(19) United States
(12) Patent Application Publication
(10) Pub. No.: US 2026/0032596 A1
(43) Pub. Date: Jan. 29, 2026

(54) MODEM DOZE MODE FOR UE POWER SAVING

(71) Applicant: Samsung Electronics Co., Ltd., Suwon-si (KR)

(72) Inventors: Yuqiang Heng, Plano, TX (US); Vutha Va, Plano, TX (US); Anum Ali, Frisco, TX (US); Boon Loong Ng, Plano, TX (US)

(21) Appl. No.: 19/060,485

(22) Filed: Feb. 21, 2025

Related U.S. Application Data
(60) Provisional application No. 63/675,972, filed on Jul. 26, 2024.

(51) Int. Cl. H04W 52/02; H04L 41/16; H04L 41/5067; H04W 76/20; H04W 76/30

(52) U.S. Cl. CPC H04W 52/0274; H04L 41/16; H04L 41/5067; H04W 76/20; H04W 76/30

(57) ABSTRACT

A method includes identifying context information of a user equipment. The method includes determining whether the context information satisfies a triggering condition. The triggering condition includes: presence of a foreground application, total packet length that the foreground application originated into a traffic buffer is less than a total packet length threshold, and a location of UE is within a cell of a gNB. The method includes in response to a determination the triggering condition is satisfied, starting a doze period including executing a doze-mode function to reduce power consumption of a modem of the UE during the doze period. The doze-mode function includes at least one of: reducing a wake-up frequency of the modem, including delaying transmission of uplink packets based on different priority classifications; selecting to transmit packets using SDT instead transitioning to RRC connected state; or transmitting an early request for RRC release to the gNB.

### CROSS-REFERENCE TO RELATED APPLICATION(S) AND CLAIM OF PRIORITY

This application claims priority under 35 U.S.C. § 119(e) to U.S. Provisional Patent Application No. 63/675,972 filed on Jul. 26, 2024. The above-identified provisional patent application is hereby incorporated by reference in its entirety.

### TECHNICAL FIELD

This disclosure relates generally to wireless communication devices. More specifically, this disclosure relates to a modem doze mode for user equipment power saving.

### BACKGROUND

Fifth generation (5G) wireless communication systems is implemented to include higher frequency (mmWave) bands, such as 28 GHz or 60 GHz bands or, in general, above 6 GHz bands, so as to accomplish higher data rates, or in lower frequency bands, such as below 6 GHZ, to enable robust coverage and mobility support. A communication system includes a DownLink (DL) that conveys signals from transmission points such as Base Stations (BSs), eNodeBs, gNodeBs or transmission reception points (TRPs) to User Equipments (UEs). Additionally, the communication system includes an UpLink (UL) that conveys signals from UEs to reception points such as gNodeBs. A UE, also commonly referred to as a terminal or a mobile station, may be fixed or mobile and may be a cellular phone, a personal computer device, etc. A gNodeB, which is generally a fixed station, may also be referred to as an access point or other equivalent terminology.

Modern network traffic is managed under the Internet protocol suite. The Transmission Control Protocol (TCP), User Datagram Protocol (UDP) and the Internet Protocol (IP) provides the foundation of how network data is packetized, addressed and routed between the sender and the receiver devices, and is responsible for establishing and maintaining a reliable connection.

The UE assistance information (UAI) framework is introduced in Release 16 of 3GPP specifications, and provides a framework wherein a UE can inform the base station (BS) about parameters that the UE prefers, including UE-preferred radio configurations. In particular, the UE can request its preferred (Radio Resource Control) RRC state. The UE maintains an active connection with the network in the RRC connected state, allowing for data transfer and signaling. In RRC idle state, the UE is not actively communicating with the network but can still receive broadcast information and can initiate the connection when necessary. The RRC inactive state allows the UE to quickly resume an active connection. Different RRC states incur different levels of power consumption for the UE: RRC connected state the highest, RRC inactive state lower and RRC idle state the lowest.

Small data transmission (SDT) is a feature introduced in Release 17 of 3GPP specifications on 5G new radio (NR). The SDT feature allows a UE that has an infrequent need to transmit a small amount of data to perform the transmission while staying in RRC inactive state, thus saving power. The UE can multiplex its data payload with the RRC Resume Request message during Random Access Channel (RACH) or through previously configured grants (CG).

### SUMMARY

This disclosure provides a modem doze mode for UE power saving.

In one embodiment, a method for a modem doze mode for UE power saving is provided. The method includes identifying context information of a UE. The method includes determining whether the context information satisfies a triggering condition. The triggering condition includes presence of a foreground application; total packet length that the foreground application originated into a traffic buffer is less than a total packet length threshold; and a location of UE is within a cell of a gNB. The method includes in response to a determination the triggering condition is satisfied, starting a doze period including executing a doze-mode function to reduce power consumption of a modem of the UE during the doze period. The doze-mode function includes at least one of: reducing a wake-up frequency of the modem, including delaying transmission of UL packets in the traffic buffer based on different priority classifications; selecting to transmit UL packets in the traffic buffer using a small data transmission (SDT) instead of selecting a transition to RRC connected state to transmit the UL packets; or transmitting an early request for RRC release to the gNB based on a time since a latest packet in the traffic buffer exceeding a threshold waiting period.

In another embodiment, an electronic device supporting a modem doze mode for UE power saving is provided. The electronic device includes a modem and a processor operably connected to the modem. The processor is configured to identify context information of the electronic device. The processor is configured to determine whether the context information satisfies a triggering condition. The triggering condition includes presence of a foreground application; total packet length that the foreground application originated into a traffic buffer is less than a total packet length threshold; and a location of UE is within a cell of a gNB. The processor is configured to in response to a determination the triggering condition is satisfied, start a doze period including executing a doze-mode function to reduce power consumption of the modem during the doze period. The doze-mode function includes at least one of: reducing a wake-up frequency of the modem, including delaying transmission of UL packets in the traffic buffer based on different priority classifications; selecting to transmit UL packets in the traffic buffer using a SDT instead of selecting a transition to RRC connected state to transmit the UL packets; or transmitting an early request for RRC release to the gNB based on a time since a latest packet in the traffic buffer exceeding a threshold waiting period.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases may be provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to this disclosure;

FIG. 2 illustrates an example gNodeB (gNB) according to this disclosure;

FIG. 3 illustrates an example UE according to this disclosure;

FIG. 4 illustrates an example method for determining whether to enter or exit a modem doze mode, according to this disclosure;

FIG. 5 illustrates an example rule-based method for determining whether to enter or exit a modem doze mode, according to this disclosure;

FIG. 6 illustrates an example method for collecting training data for training a machine-learning based (ML-based) model to generate a modem doze opportunity prediction, according to this disclosure;

FIG. 7 illustrates an example architecture of artificial intelligence (AI) based model for generating a modem doze opportunity prediction, where multi-modal input data at the UE are processed locally into a context information embedding vector, according to this disclosure;

FIG. 8 illustrates an example federated learning framework for doze opportunity prediction, according to this disclosure;

FIG. 9 illustrates an example work-flow operation of a packet priority classifier, according to this disclosure;

FIG. 10 illustrates an example method for rule-based traffic priority classification based on job information, according to this disclosure;

FIG. 11 illustrates an example method for classifying packet priority using a ML-based policy, according to this disclosure;

FIG. 12 illustrates an example method for collecting user feedback and updating a list of exempt applications and ML classification policy based on the user feedback collected, according to this disclosure;

FIG. 13 illustrates an example method for traffic shaping that includes buffering on multiple priority queues, according to this disclosure;

FIG. 14 illustrates an example method for traffic shaping that includes batching based on transmit (TX) buffer size, according to this disclosure;

FIG. 15 illustrates an example method of RRC state management for uplink data, according to this disclosure;

FIG. 16 illustrates an example RRC state modelling, according to this disclosure;
and

FIG. 17 illustrates a method for a modem doze mode for UE power saving, according to this disclosure.

### DETAILED DESCRIPTION

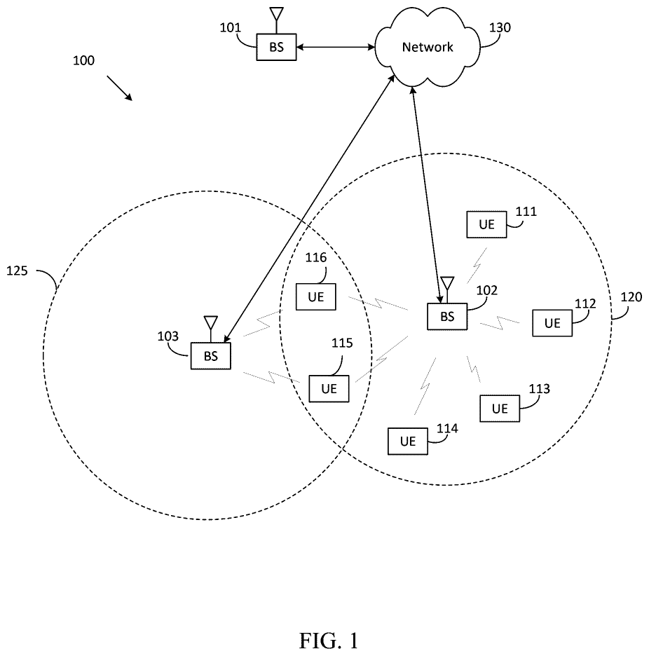

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged wireless communication system.

Aspects of the present disclosure are applicable to fifth generation (5G) communication systems, 6G or even later releases which may use THz bands. The 5G cellular communication systems deliver high data rate and low latency to support a wide range of applications, mainly achieved through means such as larger bandwidths and more antennas. An increase in power consumption associated with 5G is particularly challenging for user equipments (UEs) that rely on battery power.

The connectivity power consumption of a UE is heavily dependent on a traffic pattern of the UE. Consistent traffic requires consistent activity of the modem of the UE, thus consuming more power. On the other hand, bursty and sporadic traffic allows the modem to enter sleep states more often, which consumes less power. Embodiments of this disclosure provide advantages including significant power saving in a UE by enabling the UE to shape traffic of the UE: delaying traffic from different applications (apps) into patterns more conducive to modem sleep behavior while not impacting the Quality of Experience (QoE). On the other hand, not all packets have the same impact on the QoE: some are more tolerant to delay than others. Identifying and leveraging the priority of different packets allows the UE to save more power while providing a more robust performance on the QoE.

Embodiments of this disclosure focuses on power saving in the scenario where there is little traffic (namely, an insignificant amount of traffic that is less than a threshold amount of network activity) from the active apps on a device (such as a UE), for example, in a scenario of no set of apps (including a set of multiple apps or set of only one app) with which the user is currently interacting generate significant amounts of data. This disclosure provides solutions for QoE-aware power saving when there is little cellular traffic from active apps at the UE. The solution includes QoE-aware traffic shaping and intelligent radio resource control (RRC) state management to reduce the cellular connectivity power consumption.

More particularly, solutions provided in this disclosure includes: (i) separation of traffic packets based on their QoE requirements; (ii) traffic shaping to reduce modem active time and increase the amount of time that the modem of the UE sleeps; (iii) and intelligent usage of Small Data Transmission (SDT) and early RRC release to reduce RRC connected time. These solutions determine times when RRC connected state is unnecessary to reduce unnecessary RRC connected time. Traffic shaping techniques can increase delay, but might not affect the overall QoE of the user due to a carefully designed doze mode trigger and exit mechanism as well as QoE-aware traffic shaping solutions, which are described in this disclosure.

Note that the modem doze mode in this disclosure is different from a doze mode in an Android™ operating system (OS). The Android™ doze mode operates on an application level and batches activity of mobile applications thus affecting the behavior of multiple components, including the CPU, the memory, and the modem. In comparison, the modem doze mode in this disclosure manages the cellular traffic and only affects behavior of the modem. Furthermore, Android™ Doze mode requires the UE to be idle, which entails no user-interaction with any app, no active apps, and the device being stationary. In comparison, the modem doze mode defined in this disclosure requires the UE to be idle in terms of its cellular network activity. The UE can enter the modem doze mode as long as there is little traffic from the active apps, which intuitively includes scenarios in which the user is actively interacting with the UE (such as smartphone) and where the UE has limited mobility in the cellular management sense.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

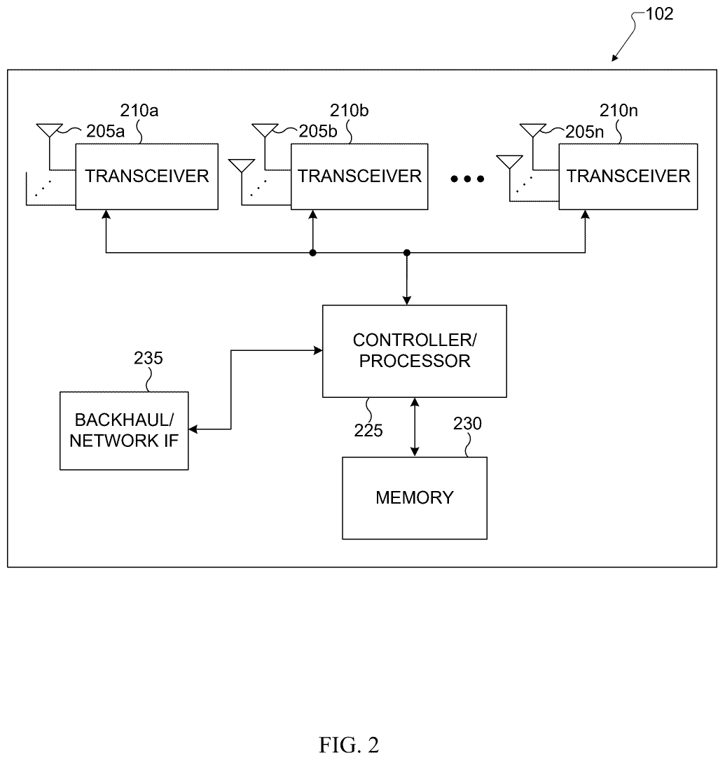

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

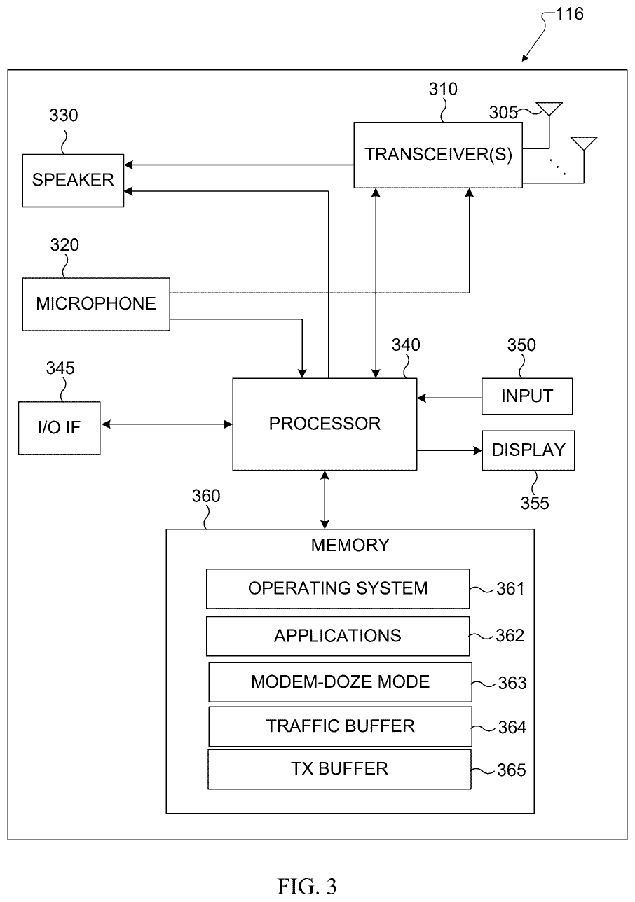

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs), one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

As another example, the processor 340 could be divided into multiple processors, such as one or more application processors (APs) and one or more communications processors (CPs). The memory 360 includes a modem doze mode 363 that the processor 340 (such as a CP) is configured to enter and exit thereby starting and ending a doze period, respectively. The processor 340 executes a doze-mode function to reduce power consumption of a modem of the UE during the doze period. The processor 340 controls the UE to enter and exit the modem doze mode 363 based on context information and signals from the OS 361, applications 363, gNBs, or an operator of the UE. The memory 360 includes a traffic buffer 364 where incoming packets (uplink packets and downlink packets) are stored before being processed or forwarded. The memory 360 also includes a transmit buffer (TX buffer) 365, where packets in the TX buffer are transmitted immediately without delay. The UE 116 includes a modem, which can include the transceiver(s) 310 and/or one or more of the CPs.

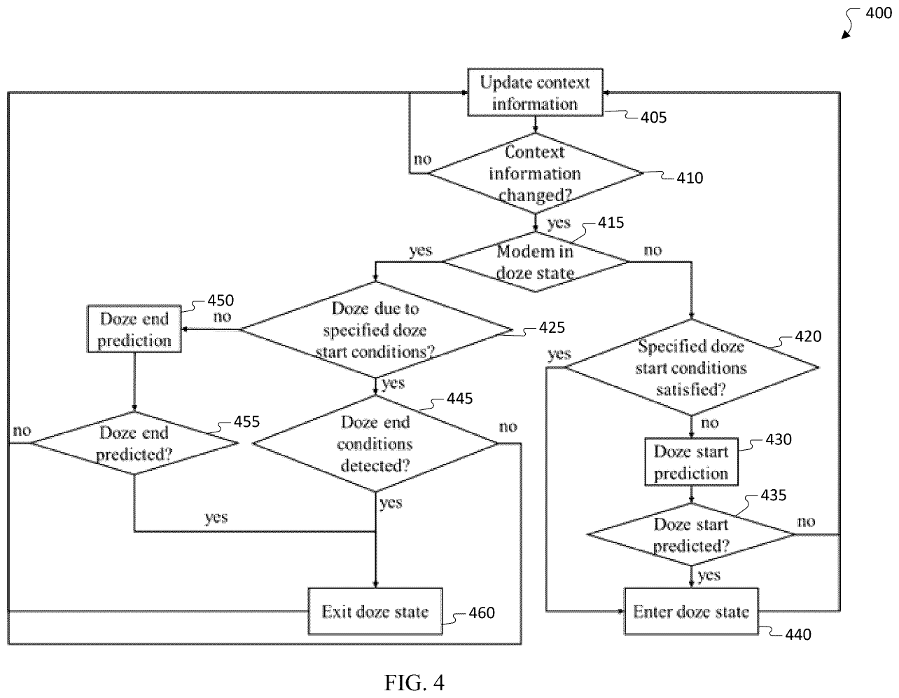

FIG. 4 illustrates an example method 400 for determining whether to enter or exit a modem doze mode, according to this disclosure. The embodiment of the method 400 shown in FIG. 4 is for illustration only, and other embodiments could be used without departing from the scope of this disclosure. The method 400 can be executed by the UE 116 of FIG. 3, such as by the processor 340 executing instructions of the modem doze mode 363, which includes a carefully designed doze mode trigger and exit mechanism, and one or more doze opportunity detection mechanisms.

The doze mode of the modem is defined as a power saving operation mode. During a doze period while the UE has entered modem doze mode, the UE will batch and delay network cellular traffic, prioritize the use of SDT, and more aggressively request RRC release so that the modem can enter deeper sleep states more often. Generally, the modem enters the doze mode when network activity from apps that are active (herein referred to as “active apps”) is below a threshold. An app is active if the app is running in the foreground and has an ongoing interaction with the user. Active apps typically have an interactive user interface (UI) or notification/status bar displayed to the user. Interruptions to active apps are more likely to be perceptible to the user and may cause degradations in the QoE. While the operator is viewing or listening to output from a active app, the operator can perceive (e.g., see or hear) an increase of latency increase or a reduction of responsiveness of active apps.

At block 405, the UE updates context information. For example, the UE identifies context information of the UE. The UE collects context information, which includes the location, user activity on the device, traffic generated on the device, time of day, etc.

At block 410, the UE determines whether context information changed. If the context information changes, the UE determines whether to enter or exit the modem doze mode.

At block 415, the UE determine whether the UE is in modem doze mode. For example, the UE determines whether modem doze mode is in an ON state or an OFF state. If the UE is not in modem doze mode (OFF state), the method proceeds from block 415 to block 420. Alternatively, if the UE is in modem doze mode (ON state), the method proceeds from block 415 to block 425.

The operating system 361 of the UE provides a setting option to enable/disable modem doze mode, which the OS can display in a settings menu for user selection, is distinct from the ON/OFF state of modem doze mode. While the setting option to enable/disable modem doze mode is disabled, the UE refrains from performing methods to determine whether to enter or exit a doze period, and refrain from executing the various methods various methods disclosed herein. On the other hand, while the setting option to enable/disable modem doze mode is enabled, the UE executes the various methods disclosed herein.

The method 400 combines the two modem-doze opportunity detection methods: rule-based and AI-based. In other words, there are two general approaches to determine whether the UE can enter the modem doze mode: based on user patterns that are heuristics-based or AI-learned. Human experts, applying their understanding of likely activity patterns, can specify rule-based conditions to enter and exit the modem doze mode. The decision logic (for example, blocks 415-435 and 445-455) is event-driven, namely, activated when the context information changes. If the UE is operating normally and not in modem doze mode, then the UE first checks whether any of the human-specified doze start conditions is satisfied. If no such specified scenarios apply, then the UE calls or triggers the ML model to predict whether current context information is a doze opportunity. Particularly at blocks 420 and 430-440, the UE determines whether to enter modem doze mode, which is to start a doze period. At blocks 425 and 445-455, the UE determines whether to exit modem doze mode, which is to end a doze period that has already begun.

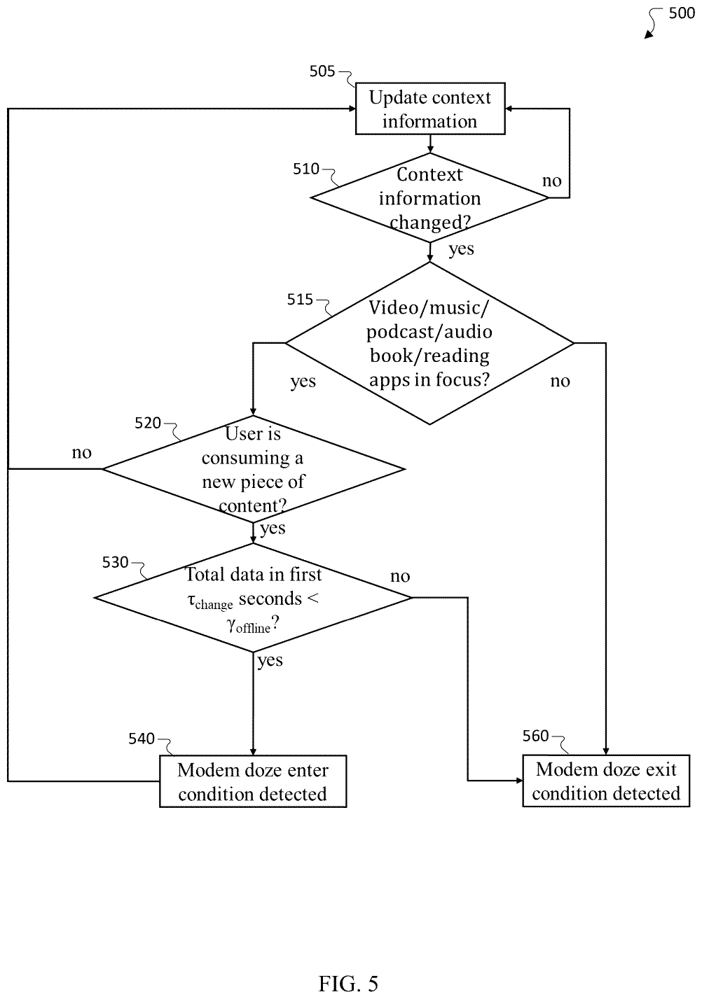

In this disclosure, a doze opportunity occurs when context information at the current time satisfies a trigger condition to switch to the ON state of the modem doze mode, and the term “doze opportunity” interchangeably refers to a doze period during which the current time and context information periodically update as time progresses so that the UE repeatedly determines whether context information at the current time satisfies the trigger condition. If any specified doze start condition is satisfied or a doze opportunity is predicted, the UE enters the modem doze mode. While the UE is currently in the modem doze mode, the UE exits the modem doze mode if exit conditions are detected, including when the user selects to exit the current active app or the user stops consuming media offline as further described with FIG. 5. If the modem doze mode is already activated due to a doze opportunity predicted by the ML model, the UE calls the doze exit prediction model to determine whether to exit doze mode.

At block 420, the UE determines whether specified doze start conditions are satisfied, thereby determining whether to doze due to specified doze start conditions. For example, the UE, using a rule-based doze opportunity detection mechanism (also referred to as rule-based detector), determines whether the context information satisfies the doze start conditions. In some embodiments, the specified doze start conditions can be included within a triggering condition to start a doze period. In such embodiments, the UE, using the rule-based detector, determines whether the context information satisfies the triggering condition. In response to a determination by the rule-based detector that the specified doze start conditions are not satisfied, the method proceeds to block 430. In response to an alternative determination by the rule-based detector that the doze start conditions are satisfied, the method proceeds to block 440 at which the UE determines to start a doze period and subsequently starts the doze period based on the doze start prediction.

At block 430, the UE uses an artificial intelligence (AI) based doze opportunity detection mechanism (also referred to as AI-based detector) trained to generate a doze start prediction, thereby inputting the updated context information into the AI-based detector. At block 435, the UE determines whether a doze start is predicted, namely, determining whether the doze start prediction output by the AI-based detector indicates a doze start is predicted. The method proceeds from block 435 to block 440 if the UE determines that the doze start is predicted, but the method restarts and returns to block 405 if a doze start is not predicted.

The procedure at block 425 is same as to procedure at block 420, as such, the UE determines whether specified doze start conditions are satisfied. In response to a determination by the rule-based detector that the doze start conditions are satisfied, the method proceeds to block 445 at which the UE determines whether specified doze end conditions are detected (for example, satisfied). In response to an alternative determination by the rule-based detector that the doze start conditions are not satisfied, the method proceeds to block 450 followed by block 455.

The method proceeds from block 445 to block 460 if the UE determines that specified doze end conditions are detected (for example, using the rule-based detector). The method restarts and returns to block 405 if the updated context information does not satisfy he doze end conditions.

At block 450, the UE uses an AI-based detector trained to generate a doze end prediction. That is, the updated context information is input to the AI-based detector.

At block 455, the UE determines whether a doze end is predicted. For example, the UE determines whether the AI-based detector output a doze end prediction indicating a doze end is predicted. The method restarts and returns to block 405 if a doze end is not predicted, for example, based on the doze end prediction output by AI-based detector not indicating a doze end. The method proceeds to block 460 if a doze end is predicted, for example, based on the doze end prediction output by AI-based detector indicating a doze end. At block 460, the UE determines to end the doze period and subsequently ends the doze period based on the doze end prediction.

Various changes can be made to the method 400 of FIG. 4, including alternative embodiments that include one or both of the rule-based and AI-based doze opportunity detection mechanisms.

FIG. 5 illustrates an example rule-based method 500 for determining whether to enter or exit a modem doze mode, according to this disclosure. The embodiment of the method 500 shown in FIG. 5 is for illustration only, and other embodiments could be used without departing from the scope of this disclosure. The method 500 can be executed by the UE 116 of FIG. 3, such as by the processor 340 executing instructions of the modem doze mode 363, which includes the rule-based detector, as introduced herein. For ease of description, the method 500 is described as performed by the rule-based detector. The procedures at blocks 505, 510, 540, and 560 of FIG. 5 can be the same as or similar to the procedures of corresponding blocks 405, 410, 440, and 460 of FIG. 4.

The rule-based detector is configured to detect rule-based doze start conditions, which can define a scenario in which the user is consuming media offline such as when the user is viewing a downloaded video, listening to downloaded audio (such as songs, podcasts, or audiobooks), or reading downloaded printable material (such as books, magazines, or textual contents) offline. Consuming media offline not only includes consumption of media in an app that in offline mode, but also includes consumption of media that has been downloaded to the UE even if the app is in online mode. Accordingly, the rule-based detector checks for online media streaming during media consumption to exit or not enter modem doze mode when a media consumption app requires a higher data rate than modem doze mode allows. The rule-based doze start conditions can be design parameters configured by a manufacturer. To detect scenarios of offline consumption of media, the UE monitors whether the user is actively using a list of media consumption apps.

On top of that, the modem doze mode 363 provides higher-level settings to users of the UE, such as a user-configurable setting for whitelisting particular apps (such as one or more selected from among the applications 362) that are exempted from modem doze mode.

Particularly, a set of whitelisted applications includes each respective whitelisted application, which is selected by the user or pre-selected by the manufacturer. These whitelisted apps may have an online usage mode, where the media content (such as video, audio, textual contents, or still image contents) are streamed or downloaded on demand in real time.

At block 515, the rule-based detector determines whether any from among the list of media consumption apps is a foreground application (such as an application in focus on the display of the UE). If so, the method proceeds to block 520, but if not, the method proceeds to block 560.

At blocks 520 and 530, the UE further monitors the network activity generated by these apps (namely, media consumption apps that are foreground applications), including monitoring whether these apps have active sockets and are generating IP packets. An IP packet generated by an app is referred to as a packet of traffic that the app originates into a traffic buffer in the UE. The user is likely using the app offline if the app does not maintain open sockets. The user is likely consuming downloaded media if the app is generating little traffic. The user is likely consuming media offline, if the total amount of downlink and uplink data over an initial τ_{change} seconds after the user opens a new piece of media content is less than a total packet length threshold γ_{offline}. Otherwise, the user is likely using the app online. The γ_{offline} parameter can be referred to as the data volume threshold, the total packet length threshold, or the doze-mode traffic threshold.

The UE may also monitor the app activity such as the app intent in the OS, to determine whether the user is trying to consume a new video, song, podcast, audiobook or book/magazine. For instance, in the Android™ OS, viewing a new video involves the app launching a new activity with viewing intent for a different video ID.

At block 520, the rule-based detector determines whether the user is consuming a new piece of content. If so, the method proceeds to block 530, but if not, the method restarts and returns to block 505. Consuming a new piece of media content is not equivalent to opening a media consumption app. Rather, consuming a new piece of media content includes opening a media content for playback or display in an app, even if the app is already opened.

Whenever the user tries to consume a new piece of content, the UE determines if the content is being consumed offline or online. At block 530, the rule-based detector determines whether a total data that these apps originated into the traffic buffer during an observation window τ_{change}, is less than a data volume threshold γ_{offline}. As an example, the total data can be defined as the total packet length of UL and DL packets that the foreground application originated into the traffic buffer. The observation window τ_{change} can also be referred to as a detection window, and can be defined as the initial τ_{change} seconds following the opening of the new piece of content.

The observation window τ_{change} and the data volume threshold γ_{offline} may be app specific. For example, video streaming apps typically have an initial buffering period during which the app aggressively downloads data to fill its video buffer. Therefore, an appropriate γ_{offline} for video streaming apps such as YouTube™ and Netflix™ may be γ_{offline}=2 MB and τ_{change}=15 seconds, assuming the UE needs to buffer at least 30 seconds of 360p video at 250 MB/hr. In comparison, for offline reading, appropriate parameter settings may be γ_{offline}=60 KB and τ_{change}=5 seconds, assuming the UE needs to download a chapter within the first 5 seconds. Typically, thirty-chapter e-book has a total size of roughly 1.5-2 MB. As another example, for audiobooks or podcasts, parameter settings may be γ_{offline}=0.5 MB and τ_{change}=5 seconds, assuming the app needs to download 1 minute of 64 Kbps audio in the first 5 seconds. For music apps, appropriate parameter values may be γ_{offline}=2 MB and τ_{change}=5 seconds, assuming the app needs to download a 3-minute long song at 96 Kbps in the first 5 seconds.

Although FIG. 5 is described in terms of consuming media offline, the rule-based detector can be configured to detect rule-based doze start conditions that define a different scenario. Other scenarios in which there is likely to be little traffic generated by active apps include: (i) when the user is editing photos, videos, and documents locally; or (ii) when the user is using fitness apps to track workouts, with no other apps requiring network connectivity. These scenarios include an activity that is unlikely to be short-lived, and the UE can maintain a list of such long-lived low-data-consumption activities. Editing documents locally can include the user writing in a journal or taking notes in a productivity app. These media editing, productivity, and fitness apps can be referred to as infrequent-connection apps that mostly operate offline with occasional network activity, such as to sync data. The UE maintains a list of such infrequent-connection apps, and detects such scenarios when these apps are active and in focus, namely, when these apps are running in the foreground and are actively being used by the user.

This list of infrequent-connection apps can include audio apps, such as music apps, podcast apps, and navigation apps in which the screen may be turned off while the user is still actively using the apps. The other scenarios in which there is likely to be little traffic generated by active apps further includes: (iii) when the user is listening to these apps while the display screen is off. The UE enters the modem doze mode when these specified scenarios are detected, and exits the doze mode when the UE is no longer in these scenarios.

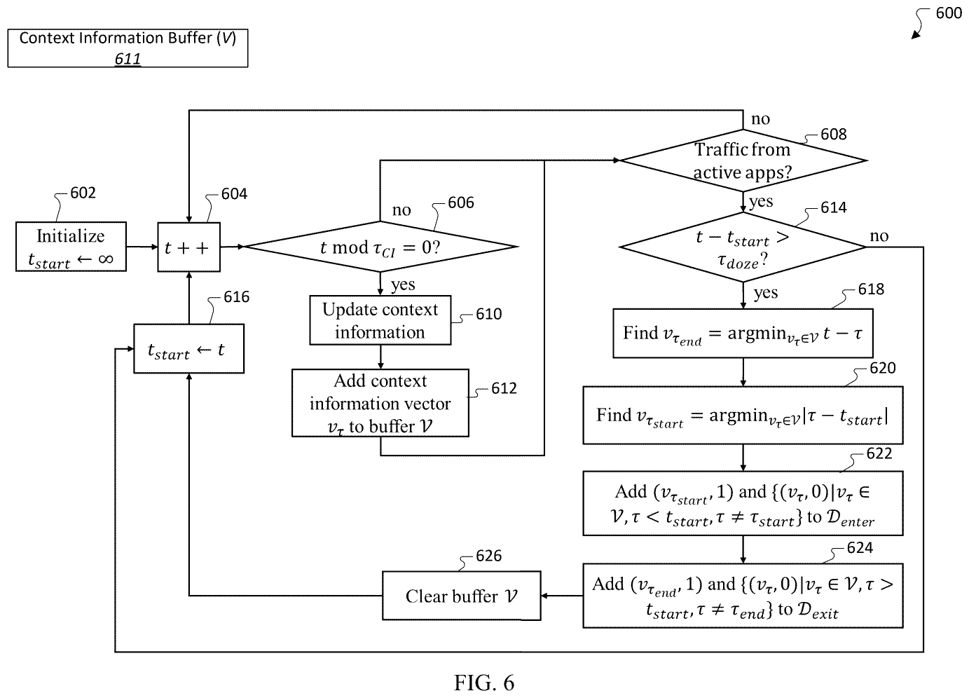

FIG. 6 illustrates an example method 600 for collecting training data for training a machine-learning based (ML-based) model to generate a modem doze opportunity prediction, according to this disclosure. The embodiment of the method 600 shown in FIG. 6 is for illustration only, and other embodiments could be used without departing from the scope of this disclosure.

The method 600 can be executed by the UE 116 of FIG. 3, such as by the processor 340 executing instructions of the modem doze mode 363. The method 600 is described as performed by the processor 340 of the UE, which generates a first dataset [symbol] ₑₙₜₑᵣ and a second dataset [symbol] ₑₓᵢₜ for training the AI-based detector introduced herein. Time is one of multiple pieces of context information used to construct the two training datasets [symbol] ₑₙₜₑᵣ, [symbol] ₑₓᵢₜ for doze mode enter and exit predictions. The method 600 initializes a tₛₜₐᵣₜ parameter at block 602 by assigning an infinite value (tₛₜₐᵣₜ=∞). Block 604 represents time progressing after the tₛₜₐᵣₜ parameter is initialized. Particularly, a current time t increments as time progresses. In some embodiments, contextual information updates at the periodicity τ_{CI}, and accordingly, a periodic timer at block 606 resets or restarts at periodic intervals τ_{CI}. For example, at block 606, a determination to update context information is made every time zero is the remainder value output from a mod function that divides the current time t and the periodic interval τ_{CI}. The method 600 proceeds from block 606 to block 608 in response to a determination that the periodic interval τ_{CI} has not elapsed, which occurs if the mod function (t mod τ_{CI}=0) outputs a non-zero remainder value.

At block 608, the UE determines whether there is any traffic from active apps. For example, the UE can determine whether an active app has added any new packets to the traffic buffer, or can determine whether the traffic buffer includes any packets originated by the active app. In response to a determination that there is no traffic from active apps, the method returns to block 604 to the current time t updates and increments. In response to a determination that there is traffic from active apps, the method includes other procedures described further below.

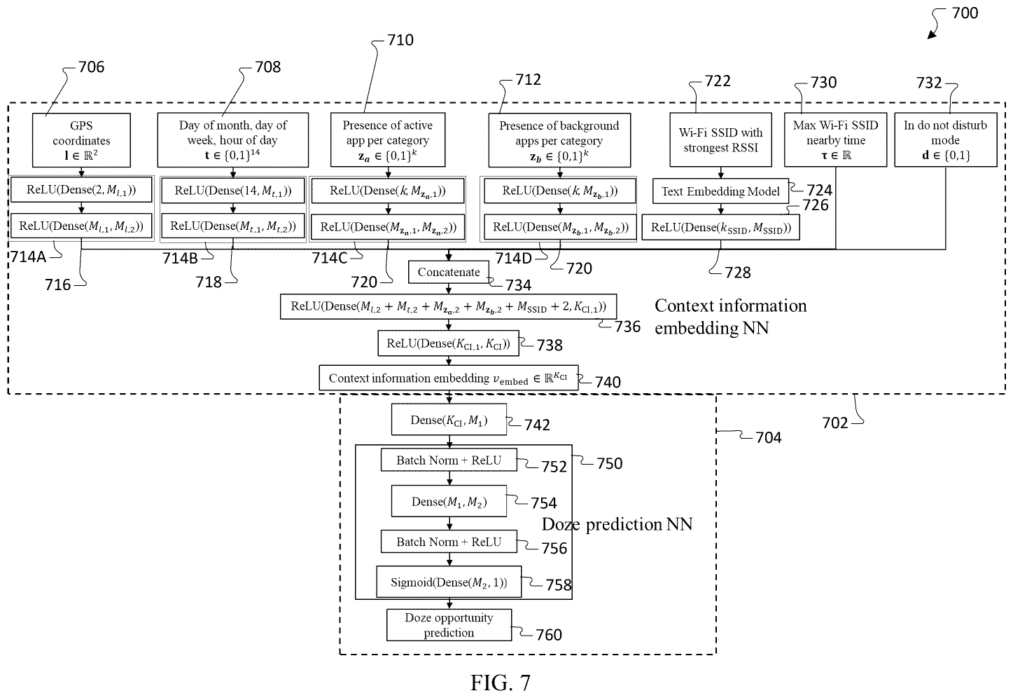

At block 610, updating context information can be the same as or similar to the procedure of corresponding block 405 of FIG. 4. In addition to expert human-specified scenarios, the UE can identify opportunities for entering and exiting modem doze mode by learning from the UE's context information accumulated over time. The UE collects context information including the time of day, GPS, nearby Wi-Fi SSIDs, recent app activities, current active apps and focus settings such as “do not disturb” and scheduled sleep times. Given the context information as inputs, machine learning (ML) models can be trained to predict opportunities to enter and exit modem doze mode. An example method for collecting training data is described further below with FIG. 7 and utilizes a context information buffer (V) 611 that is generated by and updated by the method 600 of FIG. 6. The buffer 611 can be stored in the memory 360 of FIG. 3.

The UE includes a buffer V for storing recent context information vectors, which are collected at the periodicity of T_{CI} seconds. At block 612, the UE adds context information vector v_{τ} to the buffer V, and then the method proceeds to block 608.

The variable tₛₜₐᵣₜ is updated to be the starting timestamp of a potential doze opportunity, which needs to be longer than τ_{doze} seconds to prevent frequent and unnecessary activations of modem doze mode. The parameter value of τ_{doze} can be configured based on app usage patterns. For example, videos on the Netflix™ app typically have a duration that is longer than 15 minutes, songs on Spotify™ app typically have a duration that is longer than 3 minutes, podcasts typically have a duration that is longer than 30 minutes, and it takes more than 5 minutes to read a magazine article or book chapter (assuming an average adult reading speed). Therefore, a suitable value of τ_{doze} may be 3 minutes.

In response to a determination (at block 608) that there is traffic from active apps, the method proceeds to block 614 at which the UE determines whether a specified interval Idose has elapsed since the starting timestamp tₛₜₐᵣₜ. The method proceeds to block 616 and to restart, based on a determination that the specified interval τ_{doze} has not elapsed. That is, at block 616, the UE updates and reset the starting timestamp tₛₜₐᵣₜ to the value of the current time t. The method proceeds to block 618 based on an alternative determination that the specified interval τ_{doze} elapsed, which can be the same as a determination that an interval (t-tₛₜₐᵣₜ) from the starting timestamp tₛₜₐᵣₜ to the current time t exceeds the specified interval τ_{doze}.

At blocks 618 and 620, the UE respectively determines (for example, finds or computes) the context information vector at the end of the period v_{τ}_{_{end}}, and the context information vector at the start of the period v_{τ}_{ₛₜₐᵣₜ} as shown in Equation 1 and Equation 2, respectively.

$${v}_{{τ}_{end}} = arg {min}_{{v}_{τ} ϵ V} t - τ \qquad ( 1 )$$

$${v}_{{τ}_{start}} = arg {min}_{{v}_{τ} ϵ V} \vert τ - {t}_{start} \vert \qquad ( 2 )$$

At blocks 622 and 624, the UE updates the first dataset [symbol] ₑₙₜₑᵣ and the second dataset [symbol] ₑₓᵢₜ, respectively, to add the context information vectors v_{τ}_{ₛₜₐᵣₜ} and v_{τ}_{_{end}} at the start and at the end of a doze period, respectively. The UE assigns a label to each of the context information vectors v_{τ}_{ₛₜₐᵣₜ} and v_{τ}_{_{end}} to indicate whether a QoE provided during the corresponding doze period is satisfactory or unsatisfactory. A positive label (1) indicates that a QoE requirement was satisfied during the doze period, but a negative label indicates that the doze period failed to satisfy the QoE requirement.

At block 622, a positive label (1) assigned to the context information at the start of the period v_{τ}_{ₛₜₐᵣₜ}, and the v_{τ}_{ₛₜₐᵣₜ} itself are added to the first dataset [symbol] ₑₙₜₑᵣ as (v_{τ}_{ₛₜₐᵣₜ}, 1). A negative label (0) assigned to the v_{τ}_{ₛₜₐᵣₜ}, and the v_{τ}_{ₛₜₐᵣₜ} itself are added to the first dataset [symbol] ₑₙₜₑᵣ as {v_{τ}_{ₛₜₐᵣₜ},0)|v_{τ}∈V,τ>tₛₜₐᵣₜ,τ≠τ_{end}}.

At block 624, a positive label (1) assigned to the context information at the end of the period v_{τ}_{_{end}}, and the v_{τ}_{_{end}} itself are added to the second dataset [symbol] ₑₓᵢₜ as (v_{τ}_{_{end}}, 1). A negative label (0) assigned to the v_{τ}_{_{end}}, and the v_{τ}_{_{end}} itself are added to the second dataset [symbol] ₑₓᵢₜ as {(v_{τ}_{_{end}},0)|v_{τ}∈V,τ>tₛₜₐᵣₜ,τ≠τ_{end}}. At block 626, the UE clears the buffer V, and then the method ends or proceeds to block 616 to restart.

In an example use case of the method 600, the UE monitors (for example, observes) the traffic buffer for an interval (t-tₛₜₐᵣₜ) that is at least τ_{doze} seconds. After observing at least τ_{doze} seconds with no user activity or with no data from the active apps, the context information at the start of the period v_{τ}_{ₛₜₐᵣₜ} is stored in [symbol] ₑₙₜₑᵣ and is assigned with label 1. The context information vectors outside of the observed doze period are stored in [symbol] ₑₙₜₑᵣ and are assigned with label 0. The context information vector at the end of the period v_{τ}_{_{end}} is stored in [symbol] ₑₓᵢₜ and is assigned with label 1, those during the period are stored in [symbol] ₑₓᵢₜ and assigned with label 0. Two binary classifiers are trained using [symbol] ₑₙₜₑᵣ and [symbol] ₑₓᵢₜ to predict the start and end of doze opportunities given the context information. Within the two ML-based binary classifiers, the model architecture can be eXtreme Gradient Boosting (XGBoost), Random Forest, support vector machine (SVM), or feed-forward deep neural networks (DNNs) with initial feature embedding layers.

FIG. 7 illustrates an example architecture 700 of AI-based model for generating a modem doze opportunity prediction, where multi-modal input data at the UE are processed locally into a context information embedding vector, according to this disclosure. The embodiment of the architecture 700 shown in FIG. 7 is for illustration only, and other embodiments could be used without departing from the scope of this disclosure. The architecture 700 includes an example method for collecting training data for machine learning-based modem doze opportunity prediction. The architecture 700 includes a context information embedding neural network (NN) 702 and NN architecture 704 for doze opportunity prediction.

Input data 708-712, 722, 730-732 in different modalities is transformed into a context information embedding vector 740 through the NN 702. The context information embedding vector 740 is interchangeably referred to as v_{τ} or v_{embed}.

GPS data 706 includes the GPS coordinates of the UE that are represented as a 2-dimensional vector l, which can be defined as l∈ [symbol] ². Time data 708 is represented as the day of month, day of week and hour of day, each being a one-hot vector and concatenated together, yielding a 14-dimensional multi-hot vector t, which can be defined t∈{0, 1}¹⁴.

Active app data 710 includes presence of an active app per category, where k denotes the number of categories defined, and a denotes a number of active apps from each category. Similarly, background app data 712 includes presence of background app per category, where b denotes a number of background apps from each category. The active and background apps are multi-hot vectors representing the presence (1) or absence (0) of a apps from each category. Example categories may include video streaming, music, news, browsing, fitness, social media and productivity. Each of the above input modalities 706-712 is passed through a multilayer perceptron (MLP) network 714a-714d to obtain a corresponding modality embedding vector 716-722.

The Wi-Fi SSID with the strongest RSSI is abbreviated as WSSR data 722 for simplicity. The data format of the WSSR data 722 is text. The WSSR data 722 is the SSID used as a complement to the GPS coordinates. The WSSR data 722 is first processed through a text embedding model 724 such as Word2Vec to obtain an embedding vector, then processed through an MLP 726 to obtain the modality embedding vector (MsSID) 728.

The max Wi-Fi SSID nearby time (τ) 730 is the maximum total duration an SSID appears in consecutive scans across all nearby SSIDs and is a scaler (τ∈ [symbol] ). Whether the UE is in “do not disturb” mode (including focus mode and sleep mode) is encoded a binary variable d, which can be defined as d∈{0, 1}.

All the embedding vectors 716-722 and 728 from different modalities, as well as the max Wi-Fi SSID nearby time τ 730 and do-not-disturb-mode indicator 732 are concatenated at block 734, and then processed through two fully connected layers 736 and 738 to obtain the context information embedding vector v_{embed} 740, which can be defined as v_{embed} ∈ [symbol] ^{K}^{_{CI}}. The v_{embed} 740 is then input to and processed through the doze opportunity prediction NN 704.

The context information embedding NN 702 processes the v_{embed} 740 through a fully connected network 750 to obtain (for example, to generate) the doze opportunity prediction 760. The fully connected network 750 includes a sequence of a first batch normalization with a fully connected layer 752, a dense layer 754, a second batch normalization with a fully connected layer 756, and a sigmoid activation function 758 of a second dense layer. The doze opportunity prediction 760 can be the doze start prediction 430 or the doze end prediction 450 of FIG. 4.

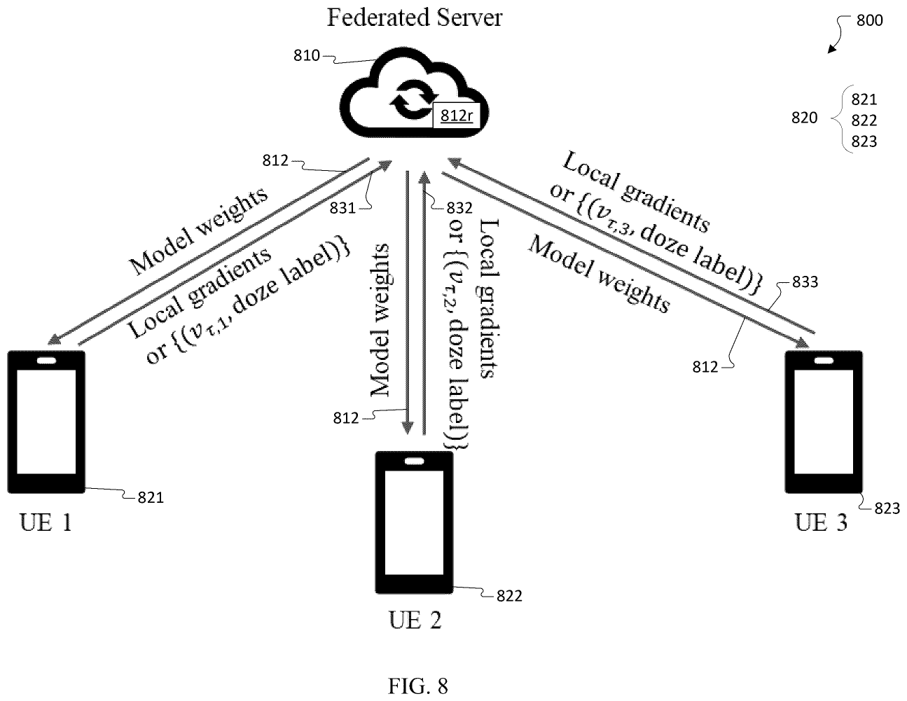

The log-likelihood or cross-entropy can be used as the loss function for training. Instead of using a single context information vector as the input for prediction, the UE may utilize the historical information from a sequence of context information vectors v_{τ} stored in the buffer V 611 (FIG. 6). This requires maintaining the sequences of context information vectors before the doze period starts and during the doze period when constructing the training datasets [symbol] ₑₙₜₑᵣ and [symbol] ₑₓᵢₜ, which can be easily achieved by modifying the procedure in FIG. 6 to store the context information update timestamps in the datasets [symbol] ₑₙₜₑᵣ and [symbol] ₑₓᵢₜ. For such time-series inputs, recurrent neural networks (RNNs) such as LSTM or transformer NNs can be trained to predict the start and end of doze opportunities by optimizing the cross-entropy loss. The training can be executed locally at each UE. Alternatively, the model can be trained in a federated fashion, as shown in FIG. 8.

FIG. 8 illustrates an example federated learning framework 800 for doze opportunity prediction, according to this disclosure. The embodiment of the framework 800 shown in FIG. 8 is for illustration only, and other embodiments could be used without departing from the scope of this disclosure.

A federated server 810 as well as all UEs within a set of UEs 820 keep (for example, store) a copy of the NN model 812 including model weights. The set of UEs 820 includes multiple UEs, including UE1 821, UE2 822, and UE3 823. For example, the NN model 812 stored in the federated server 810 can be a remote, cloud-based copy referred to as a global model 812r. Each of the UEs locally stores a copy of the NN model 812 received from the federated server 810.

Each UE 821, 822, 823 collects its own training dataset and performs local training. In one embodiment, each UE uploads feedback 831, 832, 833 including a respective gradient update of the UE's entire local NN model to the federated server 810. Then, the federated server 810 combines the gradients received from the set of UEs 820 to update the global model 812r. Then, the federated server 810 broadcasts the updated global model 812r to all UEs in the set of UEs 820, triggering each respective UE 821, 822, 823 to update its local NN model 812. As a technical advantage, the set of UEs 820 only feedback 831, 832, 833 their gradients to the federated server 810, and as a result, no sensitive information is shared (transmitted from a respective UE) and user privacy is preserved.

In another embodiment, each respective UE 821, 822, 823 performs local training of the locally stored NN model 812 and then feedbacks 831, 832, 833 the context information embedding vectors v_{τ,i} to the federated server 810. The federated server 810 stores (for example, keeps only) a copy of the doze prediction NN and uses the context information embedding vectors from all UEs in the set 820 to train a global doze prediction NN model 812r, which is then broadcasted to all UEs. This broadcast is illustrated as downlink arrows for the model weights of the NN model 812. In each training cycle, after each UE locally trains both the context information embedding NN (such as NN 702 of FIG. 7) and the doze prediction NN (such as NN 704 of FIG. 7), the UE freezes its context information embedding NN and updates its doze prediction NN with the broadcasted (812) global doze prediction NN 812r from the federated server 810. As a technical advantage, the UEs do not share any raw training data, but rather transmit the transformed context information embedding vectors to the server 810, thereby protecting user privacy. In both embodiments, the federated server 810 can utilize or federate the vast amount of data received from all UEs in the set of UEs 820 to train a better entire model (such as architecture 700 of FIG. 7) or a better doze prediction model (such as NN 704).

Although FIG. 8 illustrates an example an example federated learning framework 800 for doze opportunity prediction, various changes may be made to FIG. 8. For example, the NN model 812 stored locally within the memory a respective UE (such as UE1 821) can be a single model for all active apps. In such embodiment, the UE collects its training dataset (such as [symbol] ₑₙₜₑᵣ and [symbol] ₑₓᵢₜ) and trains its doze opportunity prediction models, which are agnostic to the active app. Alternatively, the UE may collect separate training datasets for each different active app and train doze opportunistic prediction models for each app. In some cases, app-specific models can perform better than an app-agnostic model because the data is more homogeneous in the app-specific models, although multiple app-specific models consume more storage and require more data to train.

Embodiments of this disclosure are not limited to methods of determining to enter and exit modem doze mode as described with FIGS. 4-8. According to embodiments of this disclosure, a UE executes a doze-mode function to reduce power consumption of a modem of the UE during the doze period. This disclosure provides multiple doze-mode functions: traffic shaping; small data transmission (SDT) prioritization; and requesting an early RRC release. Traffic shaping refers reducing a wake-up frequency of the modem, including delaying transmission of uplink (UL) packets in the traffic buffer based on different priority classifications. SDT prioritization refers to selecting to transmit uplink (UL) packets in the traffic buffer using SDT instead of selecting a transition to RRC connected state to transmit the UL packets. Early RRC release refers to transmitting an early request for RRC release to the gNB based on a time since a latest packet in the traffic buffer exceeding a threshold waiting period (τ_{RRC_wait}).

From among the multiple doze-mode functions, if the UE only performs traffic shaping to save power, the modem doze mode can be activated even when the UE is mobile (for example, when a motion sensor or inertial measurement unit (IMU) indicates that the UE is moving). If the UE is also actively managing its RRC connection state, the modem doze mode is activates when the UE stays within the same cell (such as coverage area 120 of FIG. 1) and is either stationary or has very little mobility. This is to prevent any impact on cellular mobility management including handover.

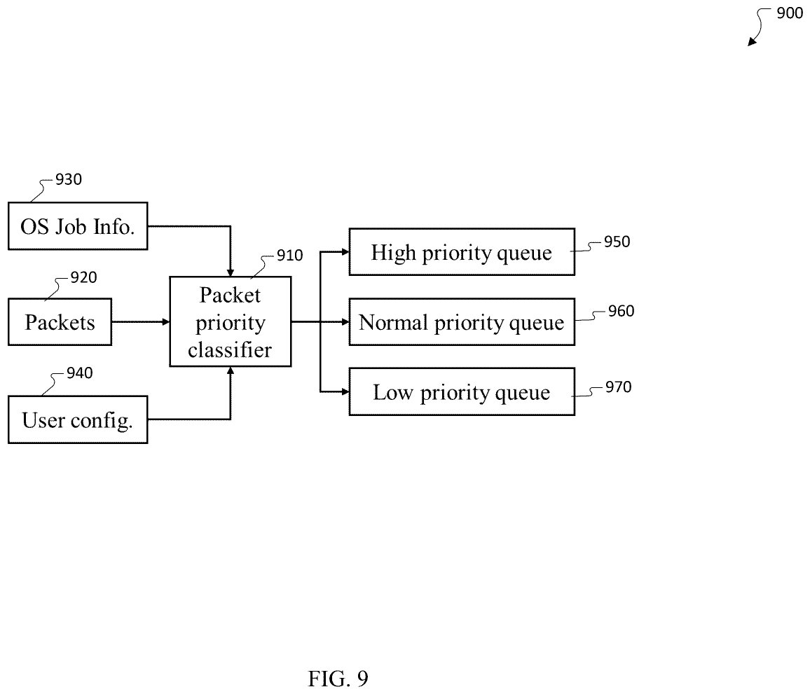

FIG. 9 illustrates an example work-flow operation 900 of a packet priority classifier 910, according to this disclosure. The embodiment of the method 900 shown in FIG. 9 is for illustration only, and other embodiments could be used without departing from the scope of this disclosure.

In order to differentially schedule data transmission without impacting user's QoE, the UE determines a priority of the network packets 920. For example, the network packets 920 can be incoming packets in the traffic buffer 364 of FIG. 1. This disclosure focuses on uplink packets at the UE because there is very little influence a UE can exert on the downlink traffic behavior.

The traffic shaping solution in this disclosure introduces an additional delay before transmitting uplink packets. Therefore, the packets are categorized into groups: high, normal and low priority based on their tolerance of the additional delay. Generally, high priority packets are critical to the user's QoE and need to be processed immediately. These high priority packets are typically generated directly from the user's interaction with the UE, such as launching an app, clicking on a new piece of content, or activities in the active apps such as watching a video playback. Normal priority packets can tolerate a moderate amount of delay, such as tens of seconds. Normal priority packets include most packets generated by background apps or by activities that do not directly interact with the user, and have little perceivable impact on the QoE. The low priority packets can tolerate a larger amount of delay, usually on the order of tens of minutes, and even hours in some cases. Packets generated due to app updates and system backups fall into this low priority class.

The packet priority classifier 910 can be rule-based or a ML-based model trained from data. The priority of packets can be determined based on system information 930 and the user's configuration 940. The system information 930 can be OS job information, which includes the priority, timing, service and originating app associated with packets. The packet priority classifier 910 assigns a priority to each packet in the traffic buffer. In one embodiment, packet priority classifier 910 puts the packet are then put into high, normal, and low priority queues 950, 960, 970 based on the priority classification of the packet. These different queues 950, 960, and 970 can represent the traffic buffer 364 of FIG. 3. The priority classification of the packet corresponds to or determines a transmission delay for the UL packet. More particularly, each of the high, normal, and low priority queues 950, 960, 970 respectively corresponds high, normal, and low scheduling periodicities (tₕ, tₙ, tₗ) that limit a tolerable amount of transmission delay for the UL packets in the corresponding priority queue. In another embodiment, instead of transferring the packets 920 into a selected queue from among the different priority queues 950, 960, 970, the packet priority classifier 910 keeps the packets 920 in the traffic buffer and associates each packet with the priority classification of the packet.

For example, the Android™ OS provides a unified framework for apps to request and schedule tasks to be executed. Apps can specify the priority level and the connectivity and timing requirement of these tasks, in addition to the underlying app and process responsible for the tasks. WorkManager in the Android™ OS is a framework for apps to schedule jobs, and uses a combination of JobScheduler and AlarmManager to schedule jobs for efficient execution. The UE can obtain a list of jobs that are currently being executed or are going to be executed, as well as their connectivity requirements. Apps can specify the priority of jobs to either high, default, or low, which determines the scheduling priority of jobs. Additionally, jobs can be expedited to be executed as soon as possible. Although the WorkManager does not directly map each job to its packets, the UE may establish an indirect mapping by cross-referencing the app responsible for each job and the responsible app's active sockets. For instance, the UE can obtain an internet protocol (IP) table that includes the originating app ID of each active TCP/IP link, which is identified by the TCP/IP 5-tuple. For each job in the WorkManager framework, the UE can identify active TCP/IP links that are created for the app by matching the app IDs in the IP table to the originating app of the job. Packets with the matching TCP/IP 5-tuples are generated by the app for the job, so that their priority level can be classified according to the information associated with the job. In another embodiment, this mapping can be provided by the app: the UE can provide an API for apps to specify the priority level of packets as well as the TCP/IP 5-tuple to filter such packets. The packets are then put into different queues 950, 960, 970 based on their priority level.

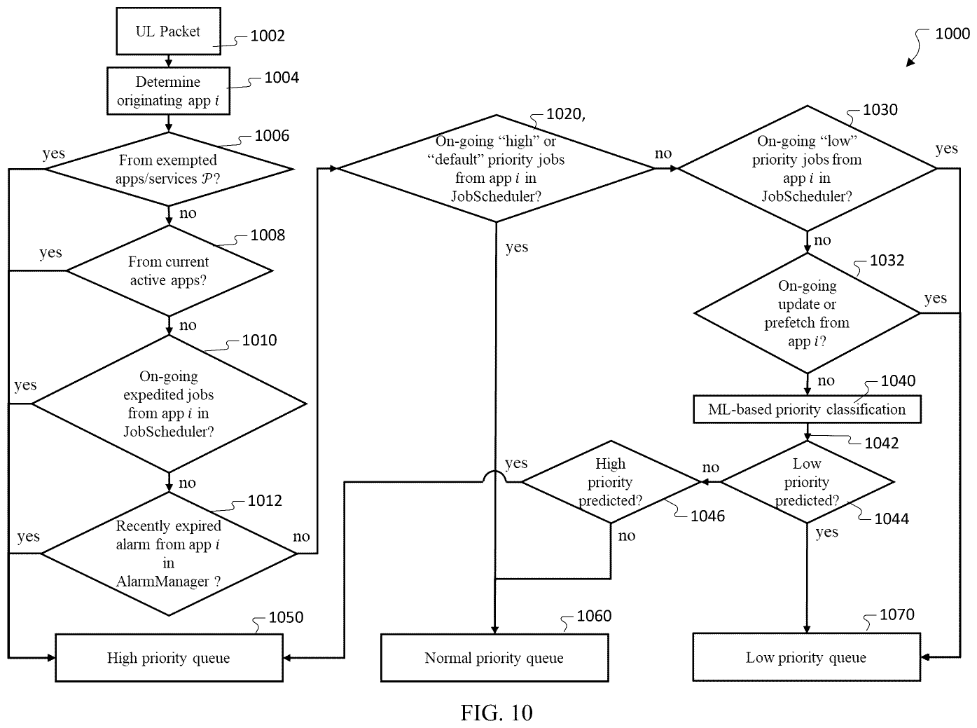

FIG. 10 illustrates an example method 1000 for rule-based traffic priority classification based on job information, according to this disclosure. More particularly, the method 1000 is an example method for a rule-based packet priority classifier leveraging OS job information while allowing user customization. The embodiment of the method 1000 shown in FIG. 10 is for illustration only, and other embodiments could be used without departing from the scope of this disclosure.

The UL packet 1002 can be a respective packet from among the packets 920 of FIG. 9. The high priority queue 1050, normal priority queue 1060, and low priority queue 1070 of FIG. 10 can represent corresponding priority queues 950, 960, 970 of FIG. 9. Accordingly, when the UL packet 1002 is assigned a high, normal, or low priority classification, the UE puts the UL packet 1002 into the corresponding high, normal, or low priority queue 1050, 1060, and 1070, respectively

This disclosure primarily describes scenarios in which there is little network activity from the active apps, most packets originate from background apps and background processes, and most packets belong to the normal priority class. In such scenarios, high priority packets are expected to arrive infrequently. The operating system of the UE can provide a set of whitelisted applications ( [symbol] ) in addition to the user-toggleable setting option to enable/disable modem doze mode, to which the user can add apps whose packets the user desires to be prioritized as the high priority. That is, packets originated by apps in this list are placed in the high priority queue 1050. While setting option to enable/disable modem doze mode is enabled, the user can specify a list of user-selected apps that are included within the set [symbol] . This provides more customizability to the user, who now has the option to make sure the QoE from the whitelisted apps are not compromised due to modem doze mode.

Packets from current in-focus or active apps likely have a significant impact on QoE, and are therefore placed in the high priority queue 1050. Some jobs in WorkManager of the Android™ OS also need to be prioritized higher than the normal priority class, including on-going expedited jobs in JobScheduler and jobs that have a recently expired alarm in AlarmManager. The packets associated with these jobs are placed in the high priority queue 1050.

At block 1004, the UE determines an originating app (indexed by i) that originating the packet 1002 in to the traffic buffer. At block 1006, the UE determines whether the originating app i is an exempted apps or exempted services from among the set of whitelisted apps ( [symbol] ). At block 1008, the UE determines whether the originating app i is from among a list of currently active apps. At block 1010, the UE determines whether the packet 1002 is associated with an on-going expedited job from the originating app i in JobScheduler. At block 1012, the UE determines whether the packet 1002 is associated with a job that a recently expired alarm from the originating app i in the AlarmManager. The UE assigns a high priority classification to the packet 1002 based on a “yes” determination at any of blocks 1006-1012, but otherwise the method proceeds to block 1020 based on “no” determination at blocks 1006, 1008, 1010, and 1012. Although blocks 1006-1012 are shown as a series of decision blocks, these procedures can be performed concurrently.

At block 1020, the UE determines whether the packet 1002 is associated with a high-priority jobs or a default-priority jobs from the originating app i in JobScheduler. Packets associated with high-priority jobs or default-priority jobs in JobScheduler are placed in the normal priority queue 1060.

At block 1030, the UE determines whether the packet 1002 is associated with a low-priority job or a default-priority jobs from the originating app i in JobScheduler. At block 1032, the UE determines whether originating app i in generated the packet 1002 due to an on-going update or a prefetch. Packets associated with low-priority jobs in JobScheduler as well as those packets generated due to app update and system update and app prefetch are placed in the low priority queue 1070.

In some embodiments, the rest of the packets are placed in the normal priority queue 1060. In some embodiments, the UE assigns a low priority classification to the packet 1002 based on a “yes” determination at any of blocks 1030-1032, but otherwise the method proceeds to block 1040 based on “no” determination at blocks 1030 and 1032. That is, The remaining packets, which are not put into priority queues 1050, 1060, 1070 up by the rule-based mechanism, are then classified using the ML-based classification policy.

At block 1040, an ML-based priority classification procedure is activated. That is, an ML-based priority classifier is triggered to generate and output a priority classification prediction 1042, in response to the packet 1002 as input. The UE assigns a low priority classification to the packet 1002, based on a determination (at block 1044) the priority classification prediction 1042 predicted (or indicates) a low priority. The UE assigns a high priority classification to the packet 1002, based on a determination (at block 1046) the priority classification prediction 1042 predicts a high priority. The UE assigns a normal priority classification to the packet 1002, based on a determination (at block 1046) the priority classification prediction 1042 predicts neither low priority nor high priority.

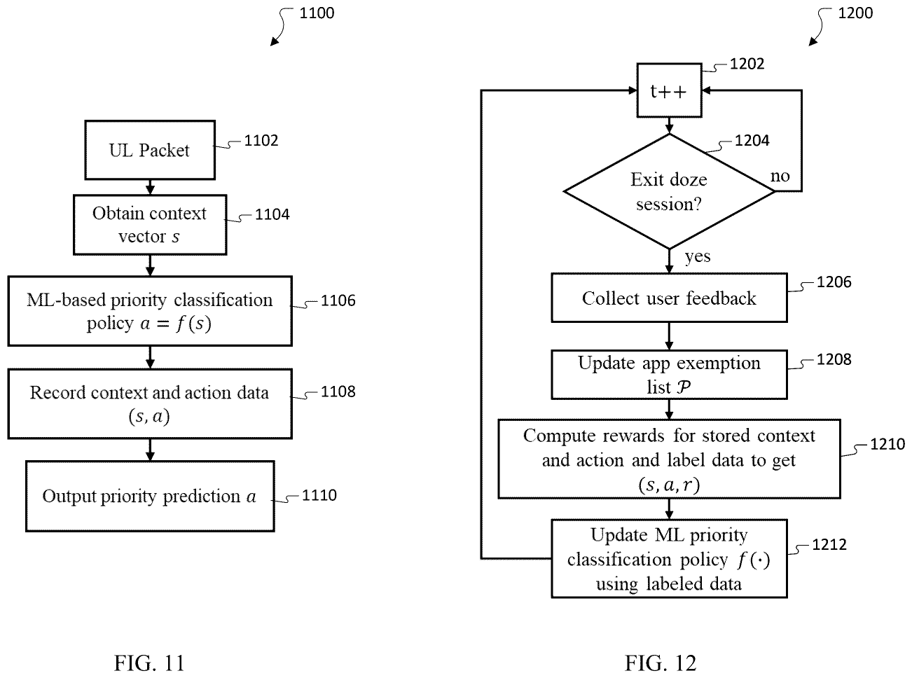

FIG. 11 illustrates an example method 1100 for classifying packet priority using a ML-based policy, according to this disclosure. The embodiment of the 1100 shown in FIG. 11 is for illustration only, and other embodiments could be used without departing from the scope of this disclosure. The method 1100 can be the same as or similar to the ML-based priority classification procedure at block 1040 of FIG. 10.

This disclosure is not limited to a rule-based solution, and provides a solution in which the UE learns a traffic priority classification policy based on user feedback through reinforcement learning (RL). The method 1100 can be executed during deployment, which is after the ML-based model has been trained.

The UL packet 1102 can be a respective packet from among the packets 920 of FIG. 9, or can be the UL packet 1002 of FIG. 10. At block 1104, the UE obtains a context vector s. The procedure at block 1104 can be the same as or similar to the procedure at block 610 of FIG. 6, or context information embedding neural network (NN) 702 of FIG. 7.

At block 1106, in response to receiving the UL packet 1102 as input, the ML-based model in the UE generates and assigns action data a to the packet 1102 by applying an ML-based priority classification policy, which is a function of the context vector a=f(s). The action a is whether to classify the priority of the packet as high, normal or low. The action data a includes a priority prediction such as the priority classification prediction 1042, and is also referred as priority classification action a or more simply as priority prediction a. For example, the priority prediction a can include a probability for each of the different possible priority classifications. The greatest probability can indicate which priority classification to be assigned to the packet 1102.

At block 1108, the UE generates and stores a record (s, a) that includes the context data (such as the context vector s) and action data a. At block 1110, the priority prediction a is output.

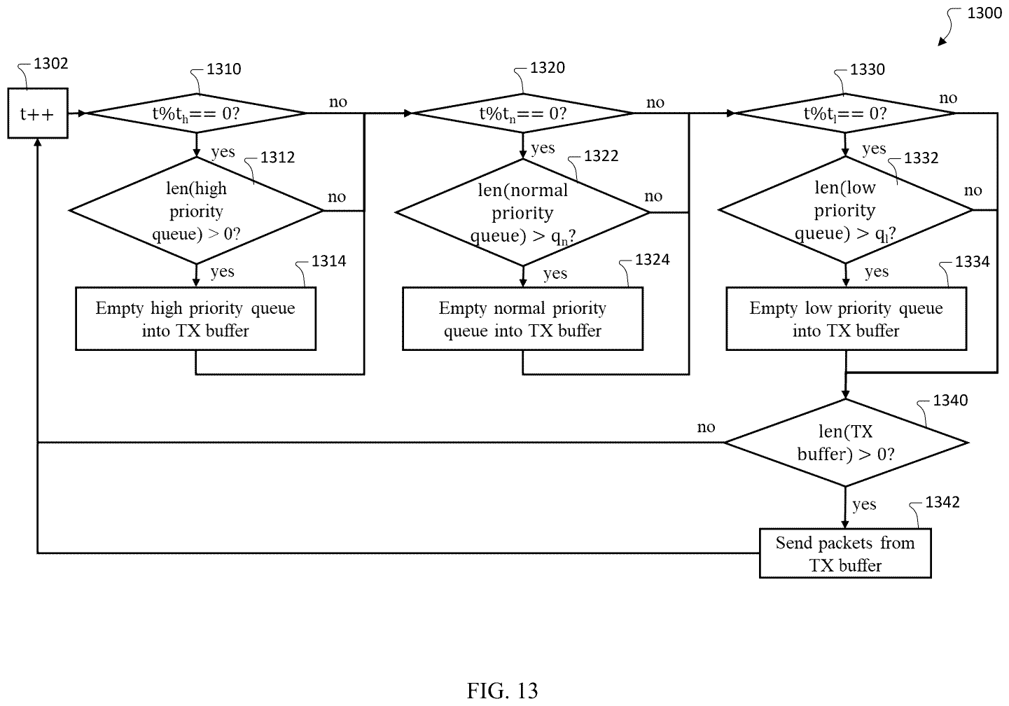

FIG. 12 illustrates an example method 1200 for collecting user feedback and updating a list of exempt applications and ML classification policy based on the user feedback collected, according to this disclosure. The embodiment of the method 1200 shown in FIG. 12 is for illustration only, and other embodiments could be used without departing from the scope of this disclosure.

At the end of a doze session, the method 1200 of FIG. 12 enables the UE to gather UE feedback and computes a reward for each classification action made to obtain a tuple (s, a, r), which is then used to update the classification policy f(·). Block 1202 represents a current time t incrementing as time progresses after the tₛₜₐᵣₜ parameter is initialized, and can be the same as block 604 of FIG. 6. During a modem doze period, the UE records each of the apps that generates traffic.

At block 1204, the UE determine whether to exit a doze period that has already begun. At block 1206, after the UE exits the modem doze mode to end the doze period, the UE selectively asks for the user's feedback regarding the QoE during the modem doze session. The UE may show a pop-up notification window that enables the user to indicate whether the user is satisfied with the experience when the UE had been in modem doze mode. The user may provide a yes/no feedback on the overall experience.

If the user indicates dissatisfaction with the QoE and the average and 5-percentile RSRP and RSRQ are below thresholds (for example, RSRP<−110 dBm and RSRQ<−16 dB), then the QoE degradation is likely caused by the doze mode. As a result, all apps that generated traffic during the session are added to the set of whitelisted apps ( [symbol] ) at block 1208, so that traffic from the apps newly added to the set [symbol] will be prioritized in the future to improve QoE.

In another embodiment, the UE can also ask (at block 1206) for more detailed feedback on the user's QoE of each app that generated traffic during the doze period. In such embodiment, at block 1208, only apps that does not provide satisfactory QoE are added to the set [symbol] .

Additionally, the UE may also record the specific app activities that generated traffic during the modem doze period. Such information can be extracted from the tag of jobs in WorkManager or from system activity log. If an app did not meet the QoE requirement as indicated by the user feedback, the app's activities during the modem doze period are added to a list of exempted services so that packets generated from the same activity by the same app will be prioritized in the future.

At blocks 1210-1212 the UE learns a traffic priority classification policy based on user feedback through reinforcement learning (RL). At block 1210, the UE generates a data-tuple of (s, a, r) by computing a reward value (r) for a stored record that includes the context vector(s) and a priority prediction (a).

In a general Markov decision process (MDP) formulation of the traffic priority classification problem, the state can be defined as a concatenated vector s=[p, c, zₐ, z_{b}, β_{avg}, β_{low}, μ_{avg}, μ_{low}], where p denotes the PID of the originating app of the packet encoded as a one-hot vector, c denotes the category of the originating app encoded as a one-hot vector (the categories defined similar to those in context information vector v_{τ} in FIG. 7), zₐ and z_{b} respectively denote the multi-hot encoded presence of active apps and background apps per category defined for doze opportunity prediction, β_{avg} and β_{low} respectively denote the average and 5-percentile serving cell RSRP observed over the previous τₘₑₐₛ seconds, μ_{avg} and μ_{low} respectively denote the average and 5-percentile serving cell RSRQ observed over the previous τₘₑₐₛ seconds. An example value of τₘₑₐₛ is 180 seconds, which captures the cellular signal quality over a minimal doze opportunity of 3 minutes, for example, as specified by the parameter value of τ_{doze}.

The reward r has a −1 value if the user provides a negative feedback regarding the QoE of the app, and has a +1 value if the user provides a positive feedback. The UE can learn a classification policy using the contextual bandit framework by treating s as the context. Algorithms such as LinUCB, NeuralUCB and Thompson sampling can be used to learn the classification policy. At block 1212, the UE updates the ML-based priority classification policy algorithm f( ) based on a data-tuple of (s, a, r).

As described above, FIGS. 10, 11, and 12 relate to packet priority classification. The packet priority classification procedure in the method 1000 of FIG. 10 combines a rule-based algorithm described with FIG. 10 and the ML-based algorithm 1100 described with FIG. 11. The method 1200 of FIG. 12 improves the ML-model used at block 1040 and 1106 of FIGS. 10 and 11, respectively.

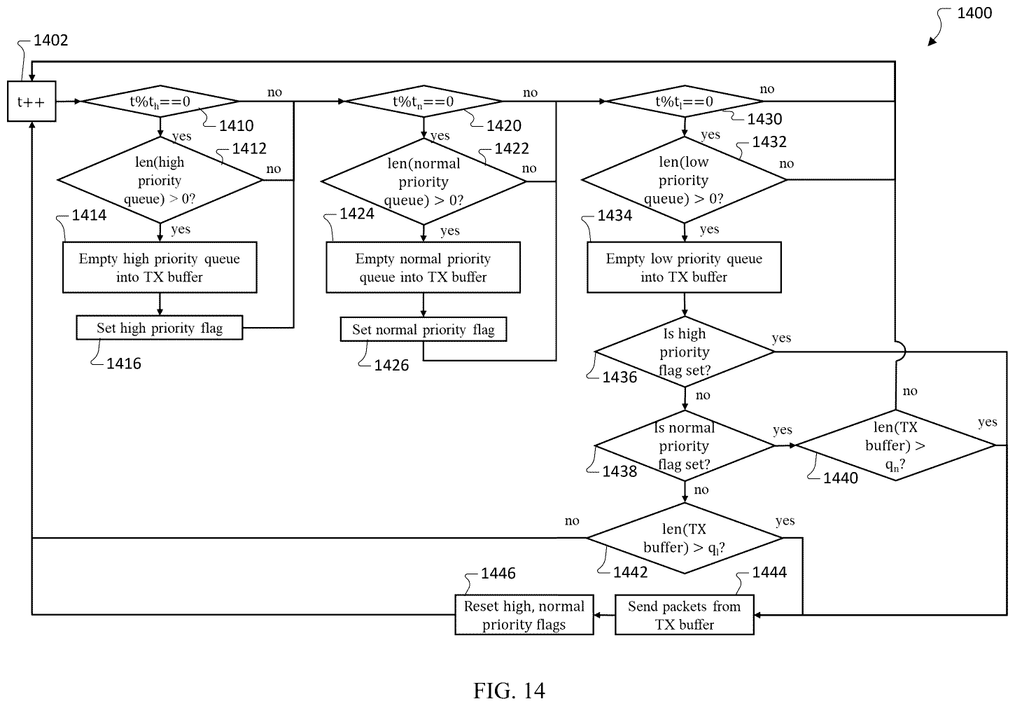

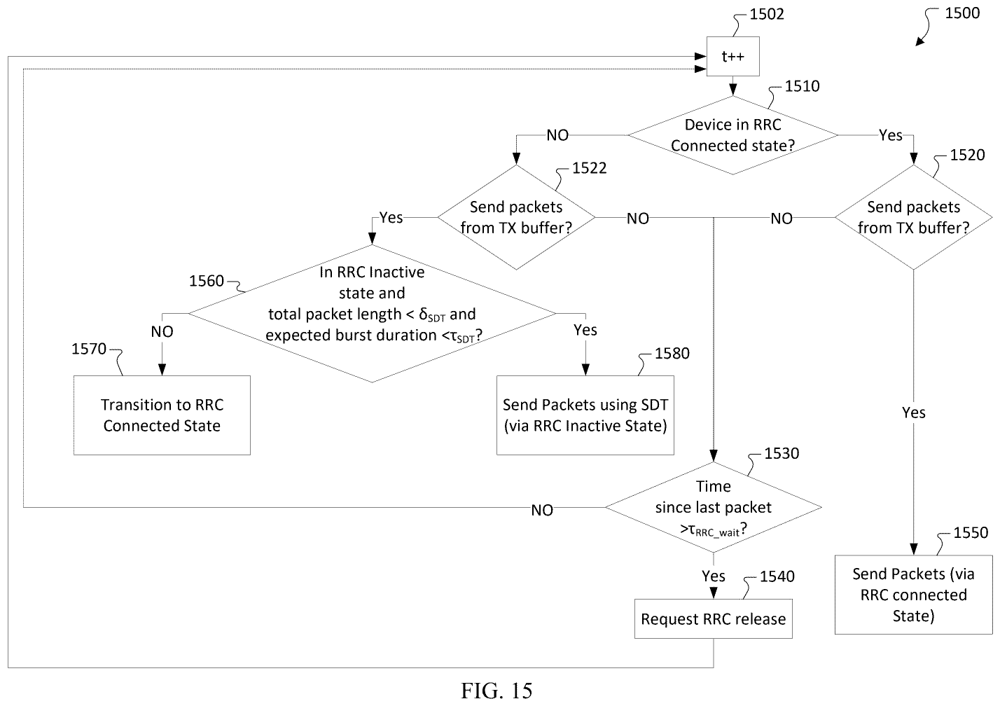

FIGS. 13 and 14 each provides an example method of traffic shaping to reduce the wake-up frequency of the modem for data transmission. In FIG. 13, different scheduling periodicities delay triggering the UE to empty different priority queues (such as 1050, 1060, and 1070 of FIG. 10) into the TX buffer 365. In FIG. 14, differently sized batching thresholds qₙ or qₗ delay transmission of packets assigned a normal priority or low priority.

FIG. 13 illustrates an example method 1300 for traffic shaping that includes buffering on multiple priority queues, according to this disclosure. The embodiment of the method 1300 shown in FIG. 13 is for illustration only, and other embodiments could be used without departing from the scope of this disclosure.

The traffic shaping module in this disclosure schedules the packets in different priority queues to reduce the wake-up time of the modem while ensuring QoE. Each of the high, normal and low priority queues has a different scheduling periodicity tₕ, tₙ and tₗ at which packets in the queue are scheduled to be transmitted. The scheduling periodicities can be chosen to ensure the maximum tolerable amount of delay for packets of each priority level. The high priority scheduling periodicity can be a small value, or even 0 if these packets are desired to be transmitted immediately.

Suitable values for tₙ can be in the order of minutes, and can be in the order of hours for tₗ. Every tₕ seconds, all packets in the high priority queue are placed into the TX buffer and scheduled to be transmitted. Every tₙ seconds, packets in the normal priority queue is scheduled for transmission. Every tₗ second, packets in the low priority queue is scheduled for transmission.

Because the modem wakes up for transmission, the UE also takes this opportunity to transmit packets with lower priority when there are higher-priority packets to be transmitted. Packets in lower priority queues (such as normal and low priority queues 1060 and 1070 of FIG. 10) are batched to reduce the modem wake-up frequency. Packets in the normal and low priority queues 1060 and 1070 are placed in the TX buffer after it is determined that the packet length of their corresponding queues exceed the corresponding batching thresholds qₙ and qₗ. This prevents the modem from waking up only to transmit a small amount of normal or low priority data, thus further reducing the modem wake-up frequency. Generally, packets are transmitted at most every tₕ seconds. When high-priority packets are rare, most of the packets are batched every tₙ or tₗ seconds depending on their priority.

Block 1302 can be the same as block 1202 of FIG. 12. A first periodic timer at block 1310 resets at an interval defined by the high-priority scheduling periodicity tₕ. For example, a determination is made at block 1312, every time zero is the output from a timer function that compares the current time t to the high-priority scheduling periodicity tₕ. At block 1312, the UE determines whether the high priority queue 1050 is not empty, namely, determining whether the packet length of the high priority queue 1050 is greater than zero. At block 1314, in response to a determination that the high priority queue 1050 is not empty, the UE empties the high priority queue 1050 into the TX buffer 365, thereby transferring all high priority uplink packets into the TX buffer. The method proceeds to block 1320 in response to a determination (at block 1310) that the interval tₕ has not elapsed, or in response to a determination (block 1312) that the high priority queue 1050 is empty, or after completion of the procedure of block 1314.

The method 1300 repeats a similar procedure for normal priority. A second periodic timer at block 1320 resets at periodic intervals tₙ. At block 1322, the UE determines whether the packet length of the normal priority queue 1060 is greater than the normal priority batching threshold qₙ. At block 1324, in response to a determination that the normal priority queue 1060 satisfies the normal batching threshold qₙ condition, the UE empties the normal priority queue 1060 into the TX buffer 365, thereby transferring all normal priority uplink packets into the TX buffer. The method proceeds to block 1330 in response to a determination (at block 1330) that the second periodic interval tₙ has not elapsed, or in response to a determination (at block 1322) that the normal priority queue 1060 does not satisfy the normal batching threshold qₙ condition, or after completion of the procedure of block 1324.

The method 1300 repeats a similar procedure for low priority. A third periodic timer at block 1330 resets or restarts at periodic intervals tₗ. At block 1332, the UE determines whether the packet length of the low priority queue 1070 is greater than the low priority batching threshold qₗ. At block 1334, in response to a determination that the low priority queue 1070 satisfies the low batching threshold qₗ condition, the UE empties the low priority queue 1070 into the TX buffer 365, thereby transferring all low priority uplink packets into the TX buffer. The method proceeds to block 1340 in response to a determination (at block 1330) that the third periodic interval tₗ has not elapsed, or in response to a determination (at block 1332) that the low priority queue 1070 does not satisfy the low batching threshold qₗ condition, or after completion of the procedure of block 1334.

At block 1340, the UE determines whether the packet length of the TX buffer 365 is greater than zero, thereby determining that the TX buffer includes at least one UL packet. At block 1342, the UE transmits packets from the TX buffer. If the TX buffer 365 is empty, then the method ends and restarts by returning to block 1302.

FIG. 14 illustrates an example method 1400 for traffic shaping that includes batching based on transmit (TX) buffer size, according to this disclosure. The embodiment of the method 1400 shown in FIG. 14 is for illustration only, and other embodiments could be used without departing from the scope of this disclosure.

In the method 1400, traffic batching is performed in the TX buffer 365 instead of the priority queues 1050, 1060, 1070. Packets from each queue are placed into the TX buffer at the specified scheduling periodicities tₕ, tₙ and tₗ. If high-priority packets are in the TX buffer, then all packets in the TX buffer are transmitted immediately. If there are only normal-priority packets or a mixture of normal-priority and low-priority packets in the TX buffer, then the TX buffer is cleared for transmission after the total amount of data of the packets exceeds qₙ bytes. If there are only low-priority packets in the TX buffer, then the TX buffer is cleared for transmission after qₗ bytes of data has been accumulated.

Blocks 1402, 1410, 1412, 1414, 1420, 1422, 1424, 1430, 1432, and 1434 in FIG. 14 can be the same as or similar to corresponding blocks 1302, 1310, 1312, 1314, 1320, 1322, 1324, 1330, 1332, and 1334 in FIG. 13. To avoid duplication, this disclosure will describe the unique features of the method 1400.

At intervals of tₕ, the UE can check for a case in which the high priority queue 1050 contains an UL packet. After the UE empties the high priority queue 1050 into the TX buffer 365, the method 1400 proceeds to block 1416 followed by block 1420. At block 1416, the UE sets a high priority flag.

At intervals of tₙ, UE can check for a case in which the normal priority queue 1060 contains an UL packet. After the UE empties the normal priority queue 1060 into the TX buffer 365, the method 1400 proceeds to block 1426 followed by block 1430. At block 1426, the UE sets a normal priority flag.

At intervals of tₗ, UE can check for a case in which the low priority queue 1070 contains an UL packet. After the UE empties the low priority queue 1070 into the TX buffer 365, the method 1400 proceeds to block 1436, at which the UE determines to transmit packets from the TX buffer if the high prior flag is set. Alternatively, if the high priority flag is not set, then the TX buffer 365 is not yet cleared for transmission, and the method proceeds to block 1438 to determine whether the normal priority flag is set.

The set/not-set state of the normal priority flag controls which among the batching thresholds qₙ or qₗ the UE selects to delay the TX buffer 365 for performing a transmission. The threshold qₗ can be greater than qₙ in order to apply a longer delay to low priority packets than to normal priority packets. If the normal priority flag is set, then the method proceeds to block 1440 to determine whether the total packet length of the TX buffer 365 satisfies the normal batching threshold qₙ condition. Alternatively, in response to a determination that the normal priority flag is not set, the method proceeds to block 1442 to determine whether the total packet length of the TX buffer 365 satisfies the low batching threshold qₙ condition. The UE determines to transmit packets from the TX buffer and the method proceeds to block 1444, in response to a determination that the total packet length of the TX buffer 365 exceeds qₙ (at block 1440) or exceeds qₗ (at block 1442). The method returns to block 1402 to restart (for example, to continue accumulating incoming UL packets) if the total packet length of the TX buffer 365 has not accumulated enough packets to exceed the batching threshold qₙ (at block 1440) or qₗ (at block 1442).

At block 1444, the UE transmits packets from TX buffer 365. At block 1446, the UE resets the high priority and normal priority flags.

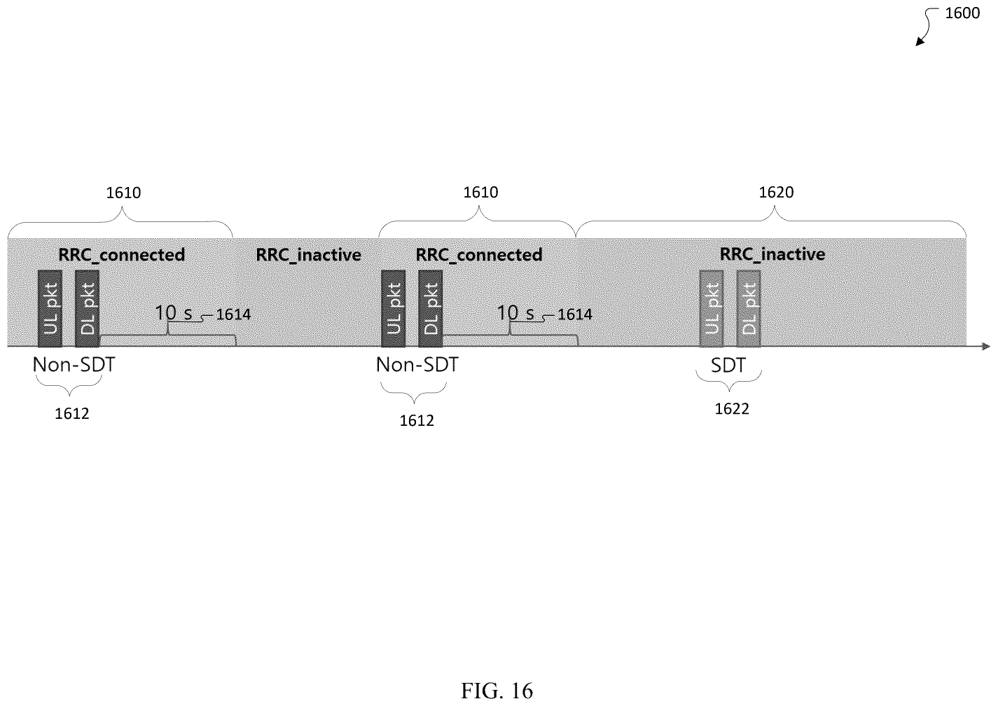

FIG. 15 illustrates an example method 1500 of RRC state management for uplink data, according to this disclosure. The embodiment of the method 1500 shown in FIG. 15 is for illustration only, and other embodiments could be used without departing from the scope of this disclosure.

In some instances, the UE needs to be in RRC connected state in order to perform data transmission. However, resuming the RRC connection is a costly procedure for the modem of the UE, particularly when the need to transmit data is infrequent and the amount of data to be transmitted is little. In Rel. 17 of the 3GPP 5G specification, small data transmission (SDT) enables UEs to send a small amount of data while staying in RRC inactive state. This disclosure enables a UE to determine a UE-preferred RRC state for UL data transmission during the modem doze mode.

The method 1500 can begin at block 1502, which can be the same as block 1202 of FIG. 12. At block 1510, the UE determines whether the UE is in RRC connected state. For example, the UE identifies a current RRC state from the context information vector vᵣ associated with the current time t. If the UE is in the RRC connected state, the UE can decide whether to be released from RRC connected state early.

At blocks 1520 and block 1522, the UE determines whether the TX buffer is non-empty. This determination can occur every tₕ, tₙ or tₗ seconds as shown at block 1340 of FIG. 13. If the TX buffer 365 is empty, then the method proceeds to block 1530.

At block 1530, if there has been no traffic for a duration of τ_{RRC_wait} seconds after the UE transmits/receives a packet, the UE requests to be released from the RRC connected state by sending its preferred RRC state to the BS through UE assistance information (UAI). That is, the UE determines whether a time since a latest packet in the traffic buffer 364 exceeds a threshold waiting period (τ_{RRC_wait}). If the UE determines at least τ_{RRC_wait} seconds have passed since the timestamp of the most recent incoming packet, then the UE transmits (at block 1540) an early request for RRC release to the gNB. For example, to transmit the early request for RRC release, the UE transmits the UE's preferred RRC state to the gNB through UAI. The method 1500 returns to block 1502 to restart based on a determination that the time since the latest packet in the traffic buffer 364 does not exceed the τ_{RRC_wait} seconds. Suitable values of τ_{RRC_wait} can be chosen based on historically observed burst durations, such as the average or 95^{th} percentile burst durations, which can also be app-specific.

Whenever the UE needs to transmit data in the modem doze mode (namely, the TX buffer is non-empty as determined at block 1520 or 1522), the UE determines a most efficient RRC state based on the amount of data and an expected duration for transmission. At block 1550, the UE sends its data (such as UL packets) without delay if the UE is already in RRC connected state. Otherwise, the UE is not already in RRC connected state, and at block 1560, the UE determines whether SDT or RRC reestablishment is more efficient to transmit the UL packets.

At block 1570, the UE transitions back to RRC connected state through RRC setup request (from idle state) or resumes request (from inactive state), if any of the following are true: (i) the UE is in RRC idle state (which does not support SDT); (ii) the total amount of UL data exceeds a total packet length threshold δ_{SDT}: or (iii) the expected burst duration a burst duration threshold (τ_{SDT}). The expected burst duration is defined as the amount of time the UE modem will be active to complete the current round of data communication. The UE can estimate the expected burst duration based on a history burst durations.

The burst duration threshold τ_{SDT} can be chosen to balance the power consumption and overhead of repeated SDT transmission and the one-time overhead of transitioning to RRC connected state. For instance, if the expected burst duration exceeds 10 seconds, then transitioning to RRC connected state may be more efficient than SDT.

The UE selects to transmit UL packets in the traffic buffer 365 using SDT instead of selecting a transition to RRC connected state to transmit the UL packets, based on a determination that a SDT transmission condition is satisfied. Satisfaction of the SDT transmission condition includes: the modem in RRC inactive state; the total packet length of UL packets in the TX buffer 365 is less than a data threshold (δ_{SDT}); and the expected burst duration is less than the burst duration threshold τ_{SDT}. Accordingly, at block 1580, the UE sends its data from the TX buffer through SDT. More particularly, the UE transmits the UL packets from the TX buffer 365 using the SDT by multiplexing the data with Physical Random Access Channel (PRACH) or RRC resume request in 4-step or 2-step RACH, or through configured grant based SDT (CG-SDT). The data threshold δ_{SDT} is a parameter configured to have a value no larger than the data volume threshold for SDT specified in 3GPP specifications, which can range from 32 to 96000 bytes depending on the network configuration. The data threshold δ_{SDT} can be configured to be the same as same as or different from the SDT threshold in various embodiments.

FIG. 16 illustrates an example RRC state transition model 1600 that includes a modem power consumption measurements of current draw during a ping test during different RRC states, according to this disclosure. The embodiment of the model 1600 shown in FIG. 16 is for illustration only, and other embodiments could be used without departing from the scope of this disclosure.

By default, the UE is in RRC connected state whenever there is a packet in the uplink or the downlink. IF there is no traffic, the UE transitions to RRC inactive state after 10 seconds.

A data burst is defined as a group of packets whose inter-arrival time is smaller than 0.32 seconds, which is the connected mode discontinuous reception (CDRX) periodicity observed in our data. Packets arriving within a CDRX cycle keeps the UE awake and tends to prevent the UE from going into CDRX sleep state. From a power consumption perspective, there is active data communication within a burst and the UE consumes the highest amount of power.

The modem power consumption is computed based on measurements of current draw in a ping test. When the UE is in RRC connected state 1610, a data burst 1612 p_{data} is 166.78 mA. During a period 1614 when the UE is in RRC connected state 1610 but not transmitting data, the current drawn p_{no_data} is 91.29 mA. In this example, during the RRC inactive state 1620, the average current drawn p_{RRC_inactive} is 21.42 mA during the ping test 1622.

The overall average current is computed as

$$\frac{{t}_{RCC\_inactive} \times {p}_{RRC\_inactive} + {t}_{data} \times {p}_{data} + {t}_{no\_data} \times {p}_{no\_data}}{total trace duration} .$$

This power model includes the power consumption by the CPU and memory and is an upper bound on the modem power consumption. The RRC state of the UE is inferred based on the IP packet trace.

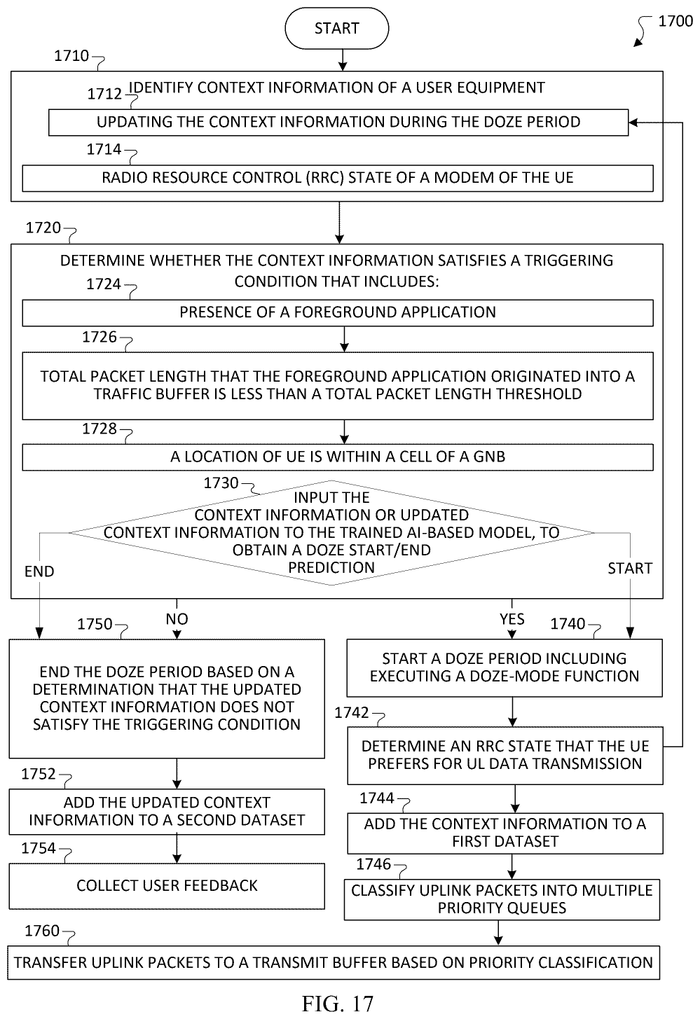

FIG. 17 illustrates a method 1700 for a modem doze mode for UE power saving, according to this disclosure. The embodiment of the method 1700 shown in FIG. 17 is for illustration only, and other embodiments could be used without departing from the scope of this disclosure. The method 1700 is implemented by an electronic device, such as the UE 116 of FIG. 3. More particularly, the method 1700 could be performed by a processor 340 of the UE 116 executing the modem-doze mode 363. For ease of explanation, the method 1700 is described as being performed by the processor 340.

At block 1710, the processor 340 identifies context information of a UE 116. At block 1712, the processor 340 updates the context information of the UE 116. Updating the context information of the UE 116 can be the same as identifying context information of the UE, and is performed outside of a doze period and performed during a doze period. The procedure of identifying or updating context information can be the same as or similar to the procedure of block 405 of FIG. 4, or block 610 of FIG. 6, or the context information embedding NN 702. At block 1714, the processor 340 determines the RRC state of the modem of the UE as context information.

At block 1720, the processor 340 determines whether the context information satisfies a triggering condition. To determine whether the context information satisfies a triggering condition the processor 340 executes a rule-based detector, an ML-based detector, or a combination of the rule-based detector and the ML-based detector. The triggering condition includes multiple factors. For example, the triggering condition is satisfied based on: presence of a foreground application, total packet length that the foreground application originated into a traffic buffer is less than a total packet length threshold δ_{SDT}, and a location of UE is within a cell of a gNB.

Blocks 1722-1728 represent rule-based factors the processor 340 applies to determine whether the context information satisfies a triggering condition, and block 1730 represent procedures that the ML-based detector executes. The triggering condition can include other factors or other rules as described in this disclosure.

At block 1724, the processor 340 determines that the context information includes information indicating which application(s) 362 if any is currently executing in the foreground, such as input 710 of FIG. 7. An example of context information that includes a presence of a foreground application is an application(s) 362 that is listed as currently executing in the foreground of the UE. Additionally, the context information includes information indicating which application(s) 362 if any is currently executing in the background, thereby indicating a presence of a background application.

At block 1726, the processor 340 determines that the context information includes of the TX buffer 365, or of the traffic buffer 364, or of the total packet length 17 #that the foreground application originated into a traffic buffer. The procedure at block 1726 can be similar to the procedure at block 1560 of FIG. 15.

At block 1728, the processor 340 determines that the context information includes a location of the UE 116 that is within a coverage area 120 of a gNB 102, such as GPS input 706 of FIG. 7 or network configuration information that indicates the serving gNB. In some embodiments, when a change of context information that indicates the location of the UE is near a border of the coverage area of the gNB, or indicates that location of the UE is likely to result in a handover, then the processor 340 can exit doze mode to prevent the UE from having to perform an initial access procedure with a new gNB instead of allowing the UE to handover.

At block 1730, the processor 340 inputs the context information to a trained AI-based model, such as after training the NN 750 of FIG. 7 or model 812 of FIG. 8. The AI-based model is trained to recognize the first user pattern and output a doze start prediction as the determination that the context information satisfies the triggering condition. The AI-based model is trained to recognize the second user pattern and output a doze end prediction as the determination that the updated context information does not satisfy the triggering condition.

To determine whether to start or to end the doze period, the AI-based detector, executes the following: in response to the determination by the rule-based detector, input the context information or the updated context information to the trained AI-based model; determine to start the doze period and subsequently starting the doze period based on the doze start prediction; and determine to end the doze period and subsequently ending the doze period based on the doze end prediction.

The method proceeds to block 1740 based on a determination that the trigger condition is satisfied. In some embodiments, at block 1740, the processor 340 starts a doze period including executing a doze-mode function to reduce power consumption of a modem of the UE during the doze period. The doze-mode function includes at least one of: reducing a wake-up frequency of the modem, including delaying transmission of uplink (UL) packets in the traffic buffer based on different priority classifications; selecting to transmit uplink (UL) packets in the traffic buffer using a small data transmission (SDT) instead of selecting a transition to RRC connected state to transmit the UL packets; or transmitting an early request for RRC release to the gNB based on a time since a latest packet in the traffic buffer exceeding a threshold waiting period τ_{RRC_wait}. The procedure at block 1740 can be the same as the procedure at block 440 of FIG. 4 or block 540 of FIG. 5.

During the doze period at block 1742, the processor 340 can determine an RRC state that the UE prefers for UL data transmission to reduce power consumption of the UE modem, and the UE can transmit this UE-preferred RRC state to the gNB through UE assistance information (UAI). That is, the UE can select to: switch to an RRC inactive state earlier than after a default 10 seconds of no traffic, as shown at block 1540 of FIG. 15; remain in RRC connected state, as shown at block 1550 of FIG. 15; or transmit UL packets in RRC inactive state using SDT, as shown at block 1580. During the doze period at block 1744, the processor 340 adds the context information to a first dataset [symbol] ₑₙₜₑᵣ.

During the doze period at block 1746, the processor 340 classifies uplink packets into high, normal, and low priority queues based on different quality of experience (QoE) impacts of the uplink packets that respectively correspond to the different priority classifications.

At block 1760, the processor 340 transfers UL packets to the TX buffer 365. The processor 340 transmits or schedules transmission of the UL packets to occur at a time that is based on the priority classification. For example, the processor 340 can transfer UL packets from the low priority queue to the TX buffer after the packet length of the low priority queue exceeds a low packet length threshold qₗ, based on a determination that the high and normal priority queues are empty.

The method proceeds to block 1750 based on a determination that the trigger condition is not satisfied. At block 1750, the processor 340 ends the doze period. Based on a determination that the updated context information does not satisfy the triggering condition, the UE ends the doze period, for example by inputting the updated context information to the trained AI-based model to recognize a second user pattern and output a doze end prediction as the determination that the updated context information does not satisfy the triggering condition.

At block 1752 upon ending the doze period, the processor 340 adds the updated context information to a second dataset [symbol] ₑₓᵢₜ, as shown at block 624 of FIG. 6. At block 1754 after ending the doze period, the processor 340 collects user feedback of whether a user of the UE is satisfied with a quality of experience (QoE) during the doze period, as described herein with block 1206 of FIG. 12.

In some embodiments, the processor 340 updates a set of whitelisted applications associated with a high priority classification for packets a respective whitelisted application originates into the traffic buffer, based on the user feedback collected at block 1754. Further, the processor 340 computes a reward value (r) for a vector (s) of context data and a priority classification action (a) corresponding to the vector. The processor 340 updates an ML-based priority classification algorithm based on a data-tuple of (s, a, r).

In some embodiments, the rule-based detector determines that the context information satisfies the triggering condition based on at least one of: identifying that user activity on the UE corresponds to a list of long-lived low-data-consumption activities; or identifying the foreground application is a fitness application, and a presence of foreground and background applications includes no other applications that require network connectivity.

In some embodiments, the rule-based detector determines that the context information satisfies the triggering condition based on: identifying the foreground application among a list of different media consumption applications; determining that user activity on the UE corresponds to opening a new piece of content within the foreground application; and determining the total packet length that the foreground application originated into the traffic buffer within a detection window relative to the opening of the new piece of content is less than a doze-mode traffic threshold. The list of different media consumption applications correspond to different detection windows and different doze-mode traffic thresholds.

In some embodiments, the processor 340 transfers uplink packets, to a TX buffer for immediate transmission, from the high priority queue, the normal priority queue, and the low priority queue, sequentially according to high, normal, and low scheduling periodicities that limit a tolerable amount of transmission delay for the UL packets in the corresponding priority queue. In some embodiments, the processor 340 can transfer UL packets from the high, normal, and low priority queues to a transmit buffer for immediate transmission, based on a determination that the high priority queue is not empty. The processor 340 transfers UL packets from the normal and low priority queues to the TX buffer after a combined packet length of the normal and low priority queues exceeds a normal packet length threshold, based on a determination that the high priority queue is empty and that the normal priority queue is not empty. The processor 340 transfers UL packets from the low priority queue to the TX buffer after the packet length of the low priority queue exceeds a low packet length threshold, based on a determination that the high and normal priority queues are empty.

In some embodiments, the processor 340 selects to transmit and subsequently transmitting the UL packets using the SDT, based on a determination that a SDT transmission condition is satisfied. The processor 340 selects to transition to RRC connected state to transmit the UL packets, based on a determination that the SDT transmission condition is not satisfied. Satisfaction of the SDT transmission condition can be the same as described herein with block 1580 of FIG. 15.

Although FIG. 17 illustrates an example a method 1700 for a modem doze mode for UE power saving, various changes may be made to FIG. 17. For example, while shown as a series of steps, various steps in FIG. 17 could overlap, occur in parallel, occur in a different order, or occur any number of times. As a particular example, the rule-based detector can operate in parallel with the ML-based detector to concurrently determine whether context information satisfies a triggering condition, and thereby determine whether to enter/start or exit/end the modem-doze mode 363.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
identifying context information of a user equipment (UE);
determining whether the context information satisfies a triggering condition that includes:
presence of a foreground application,
total packet length that the foreground application originated into a traffic buffer is less than a total packet length threshold, and
a location of UE is within a cell of a gNB; and
in response to a determination the triggering condition is satisfied, starting a doze period including executing a doze-mode function to reduce power consumption of a modem of the UE during the doze period, wherein the doze-mode function includes at least one of:
reducing a wake-up frequency of the modem, including delaying transmission of uplink (UL) packets in the traffic buffer based on different priority classifications;
selecting to transmit UL packets in the traffic buffer using a small data transmission (SDT) instead of selecting a transition to RRC connected state to transmit the UL packets; or
transmitting an early request for RRC release to the gNB based on a time since a latest packet in the traffic buffer exceeding a threshold waiting period.

2. The method of claim 1, further comprising:
adding the context information to a first dataset for training an artificial intelligence (AI) based model to generate a doze start prediction based on a first user pattern learned from the first dataset;
updating the context information during the doze period;
adding the updated context information to a second dataset for training the AI-based model to generate a doze end prediction based on a second user pattern learned from the second dataset;
inputting the context information to the trained AI-based model to recognize the first user pattern and output a doze start prediction as the determination that the context information satisfies the triggering condition; and
ending the doze period including based on a determination that the updated context information does not satisfy the triggering condition, including:
inputting the updated context information to the trained AI-based model to recognize the second user pattern and output a doze end prediction as the determination that the updated context information does not satisfy the triggering condition.

3. The method of claim 2, further comprising:
determining, by a rule-based detector, that the context information does not satisfy the triggering condition; and
determining, by an AI-based detector, whether to start or to end the doze period, including:
in response to the determination by the rule-based detector, inputting the context information or the updated context information to the trained AI-based model;
determining to start the doze period and subsequently starting the doze period based on the doze start prediction; and
determining to end the doze period and subsequently ending the doze period based on the doze end prediction.

4. The method of claim 1, further comprising determining, by a rule-based detector, that the context information satisfies the triggering condition based on at least one of:
identifying that user activity on the UE corresponds to a list of long-lived low-data-consumption activities; or
identifying the foreground application is a fitness application, and a presence of foreground and background applications includes no other applications that require network connectivity.

5. The method of claim 1, further comprising determining, by a rule-based detector, that the context information satisfies the triggering condition based on:
identifying the foreground application among a list of different media consumption applications;
determining that user activity on the UE corresponds to opening a new piece of content within the foreground application; and
determining the total packet length that the foreground application originated into the traffic buffer within a detection window relative to the opening of the new piece of content is less than a doze-mode traffic threshold.

6. The method of claim 5, wherein the list of different media consumption applications correspond to different detection windows and different doze-mode traffic thresholds.

7. The method of claim 1, further comprising:
classifying uplink packets into high, normal, and low priority queues based on different quality of experience (QoE) impacts of the uplink packets that respectively correspond to the different priority classifications; and
transferring uplink packets, to a transmit buffer for immediate transmission, from the high priority queue, the normal priority queue, and the low priority queue, sequentially according to high, normal, and low scheduling periodicities that limit a tolerable amount of transmission delay for the UL packets in the corresponding priority queue.

8. The method of claim 1, further comprising:
classifying uplink packets into high, normal, and low priority queues based on different quality of experience (QoE) impacts of the UL packets that respectively correspond to the different priority classifications;
transferring UL packets from the high, normal, and low priority queues to a transmit (TX) buffer for immediate transmission, based on a determination that the high priority queue is not empty;
transferring UL packets from the normal and low priority queues to the TX buffer after a combined packet length of the normal and low priority queues exceeds a normal packet length threshold, based on a determination that the high priority queue is empty and that the normal priority queue is not empty; and
transferring UL packets from the low priority queue to the TX buffer after the packet length of the low priority queue exceeds a low packet length threshold, based on a determination that the high and normal priority queues are empty.

9. The method of claim 1, further comprising:
selecting to transmit and subsequently transmitting the UL packets using the SDT, based on a determination that a SDT transmission condition is satisfied; and
selecting to transition to RRC connected state to transmit the UL packets, based on a determination that the SDT transmission condition is not satisfied,
wherein satisfaction of the SDT transmission condition includes:
the modem in RRC inactive state;
the total packet length that the foreground application originated into the traffic buffer is less than a data threshold that is limited by the SDT; and
an expected burst duration is less than a burst duration threshold.

10. The method of claim 1, further comprising:
after ending the doze period, collecting user feedback of whether a user of the UE is satisfied with a quality of experience during the doze period;
updating a set of whitelisted applications associated with a high priority classification for packets a respective whitelisted application originates into the traffic buffer, based on the user feedback;
computing a reward value (r) for a vector (s) of context data and a priority classification action (a) corresponding to the vector; and
updating a machine-learning priority classification algorithm based on a data-tuple of (s, a, r).

11. An electronic device comprising:
a modem; and
a processor operably connected to the modem and configured to:
identify context information of the electronic device;
determine whether the context information satisfies a triggering condition that includes:
presence of a foreground application,
total packet length that the foreground application originated into a traffic buffer is less than a total packet length threshold, and
a location of electronic device is within a cell of a gNB; and
in response to a determination the triggering condition is satisfied, start a doze period including executing a doze-mode function to reduce power consumption of the modem during the doze period, wherein the doze-mode function includes at least one of:
reducing a wake-up frequency of the modem, including delaying transmission of uplink (UL) packets in the traffic buffer based on different priority classifications;
selecting to transmit UL packets in the traffic buffer using a small data transmission (SDT) instead of selecting a transition to RRC connected state to transmit the UL packets; or
transmitting an early request for RRC release to the gNB based on a time since a latest packet in the traffic buffer exceeding a threshold waiting period.

12. The electronic device of claim 11, wherein the processor is further configured to:
add the context information to a first dataset for training an artificial intelligence (AI) based model to generate a doze start prediction based on a first user pattern learned from the first dataset;
update the context information during the doze period;
add the updated context information to a second dataset for training the AI-based model to generate a doze end prediction based on a second user pattern learned from the second dataset;
input the context information to the trained AI-based model to recognize the first user pattern and output a doze start prediction as the determination that the context information satisfies the triggering condition; and
end the doze period including based on a determination that the updated context information does not satisfy the triggering condition, including to:
input the updated context information to the trained AI-based model to recognize the second user pattern and output a doze end prediction as the determination that the updated context information does not satisfy the triggering condition.

13. The electronic device of claim 12, wherein the processor is further configured to:
determine, by a rule-based detector, that the context information does not satisfy the triggering condition; and
determine, by an AI-based detector, whether to start or to end the doze period, including:
in response to the determination by the rule-based detector, input the context information or the updated context information to the trained AI-based model;
determine to start the doze period and subsequently starting the doze period based on the doze start prediction; and
determine to end the doze period and subsequently ending the doze period based on the doze end prediction.

14. The electronic device of claim 11, wherein to determine that the context information satisfies the triggering condition, the processor is further configured to use a rule-based detector to:
identify that user activity on the electronic device corresponds to a list of long-lived low-data-consumption activities; or
identify the foreground application is a fitness application, and a presence of foreground and background applications includes no other applications that require network connectivity.

15. The electronic device of claim 11, wherein to determine that the context information satisfies the triggering condition, the processor is further configured to use a rule-based detector to:
identify the foreground application among a list of different media consumption applications;
determine that user activity on the electronic device corresponds to opening a new piece of content within the foreground application; and
determine the total packet length that the foreground application originated into the traffic buffer within a detection window relative to the opening of the new piece of content is less than a doze-mode traffic threshold.

16. The electronic device of claim 15, wherein the list of different media consumption applications correspond to different detection windows and different doze-mode traffic thresholds.

17. The electronic device of claim 11, wherein the processor is further configured to:
classify uplink packets into high, normal, and low priority queues based on different quality of experience (QoE) impacts of the uplink packets that respectively correspond to the different priority classifications; and
transfer uplink packets, to a transmit buffer for immediate transmission, from the high priority queue, the normal priority queue, and the low priority queue, sequentially according to high, normal, and low scheduling periodicities that limit a tolerable amount of transmission delay for the UL packets in the corresponding priority queue.

18. The electronic device of claim 11, wherein the processor is further configured to:
classify uplink packets into high, normal, and low priority queues based on different quality of experience (QoE) impacts of the UL packets that respectively correspond to the different priority classifications;
transfer UL packets from the high, normal, and low priority queues to a transmit (TX) buffer for immediate transmission, based on a determination that the high priority queue is not empty;
transfer UL packets from the normal and low priority queues to the TX buffer after a combined packet length of the normal and low priority queues exceeds a normal packet length threshold, based on a determination that the high priority queue is empty and that the normal priority queue is not empty; and
transfer UL packets from the low priority queue to the TX buffer after the packet length of the low priority queue exceeds a low packet length threshold, based on a determination that the high and normal priority queues are empty.

19. The electronic device of claim 11, wherein the processor is further configured to:
select to transmit and subsequently transmitting the UL packets using the SDT, based on a determination that a SDT transmission condition is satisfied; and
select to transition to RRC connected state to transmit the UL packets, based on a determination that the SDT transmission condition is not satisfied,
wherein satisfaction of the SDT transmission condition includes:
the modem in RRC inactive state;
the total packet length that the foreground application originated into the traffic buffer is less than a data threshold that is limited by the SDT; and
an expected burst duration is less than a burst duration threshold.

20. The electronic device of claim 11, wherein the processor is further configured to:
after ending the doze period, collect user feedback of whether a user of the electronic device is satisfied with a quality of experience during the doze period;
update a set of whitelisted applications associated with a high priority classification for packets a respective whitelisted application originates into the traffic buffer, based on the user feedback;
compute a reward value (r) for a vector (s) of context data and a priority classification action (a) corresponding to the vector; and
update a machine-learning priority classification algorithm based on a data-tuple of (s, a, r).
